(19) United States
(12) Patent Application Publication
(10) Pub. No.: US 2022/0292366 A1
(43) Pub. Date: Sep. 15, 2022

(54) METHODS AND APPARATUS TO PERFORM LOW OVERHEAD SPARSITY ACCELERATION LOGIC FOR MULTI-PRECISION DATAFLOW IN DEEP NEURAL NETWORK ACCELERATORS

(71) Applicant: Intel Corporation, Santa Clara, CA (US)

(72) Inventors: Arnab Raha, Santa Clara, CA (US); Martin Langhammer, Alderbury (GB); Debabrata Mohapatra, Santa Clara, CA (US); Nihat Tunali, San Jose, CA (US); Michael Wu, Belmont, CA (US)

(21) Appl. No.: 17/709,337

(22) Filed: Mar. 30, 2022

(51) Int. Cl. G06N 3/10; G06N 3/04

(52) U.S. Cl. CPC G06N 3/10; G06N 3/0481

(57) ABSTRACT

Methods, apparatus, systems, and articles of manufacture to perform low overhead sparsity acceleration logic for multi-precision dataflow in deep neural network accelerators are disclosed. An example apparatus includes a first buffer to store data corresponding to a first precision; a second buffer to store data corresponding to a second precision; and hardware control circuitry to: process a first multibit bitmap to determine an activation precision of an activation value, the first multibit bitmap including values corresponding to different precisions; process a second multibit bitmap to determine a weight precision of a weight value, the second multibit bitmap including values corresponding to different precisions; and store the activation value and the weight value in the second buffer when at least one of the activation precision or the weight precision corresponds to the second precision.

### FIELD OF THE DISCLOSURE

This disclosure relates generally to machine learning, and, more particularly, to methods and apparatus to perform low overhead sparsity acceleration logic for multi-precision dataflow in deep neural network accelerators.

### BACKGROUND

In recent years, artificial intelligence (e.g., machine learning, deep learning, etc.) have increased in popularity. Artificial intelligence may be implemented using neural networks. Neural networks are computing systems inspired by the neural networks of human brains. A neural network can receive an input and generate an output. The neural network includes a plurality of neurons corresponding to weights can be trained (e.g., can learn, be weighted, etc.) based on feedback so that the output corresponds a desired result. Once the weights are trained, the neural network can make decisions to generate an output based on any input. Neural networks are used for the emerging fields of artificial intelligence and/or machine learning. A deep neural network is a particular type of neural network that includes multiple layers of neurons between an input and an output.

### BRIEF DESCRIPTION OF THE DRAWINGS

FIG. 1 is a schematic illustration of an example deep neural network.

FIG. 2 is a block diagram of example implementation of a processing element of the deep neural network of FIG. 1.

FIG. 3A-3C illustrate example circuitry that may be included in the example processing element of FIG. 1.

FIG. 4 is a block diagram of an example implementation of two layers of the deep neural network of FIG. 1.

FIGS. 5-10 illustrate a flowchart representative of example machine readable instructions which may be executed to implement the example processing element of FIGS. 1-4.

FIG. 11 is a block diagram of an example processing platform structured to execute the instructions of FIGS. 5-10 to implement the example processing element of FIGS. 1-4.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform to distribute software (e.g., software corresponding to the example computer readable instructions of FIGS. 5-10 to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Although the figures show layers and regions with clean lines and boundaries, some or all of these lines and/or boundaries may be idealized. In reality, the boundaries and/or lines may be unobservable, blended, and/or irregular.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but may be used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Machine learning models, such as neural networks, are used to perform a task (e.g., classify data). Machine learning can include a training stage to train the model using ground truth data (e.g., data correctly labelled with a particular classification). Training a traditional neural network adjusts the weights of neurons of the neural network. After trained, data is input into the trained neural network and the weights of the neurons are applied (e.g., multiplied and accumulate (MAC)) to input data to be able to process the input data to perform a function (e.g., classify data). For example, each neuron can be implemented by a MAC processing element (PE) that obtains input data and/or output data of a previous layer (e.g., activation data) and multiplies the input/activation data with the weights developed from training to generate output values for the neuron. As used herein, the terms data element and activation are interchangeable and mean the same thing. In particular, as defined herein, a data element or an activation is a compartment of data in a data structure. The output values may be transmitted to a subsequent layer and/or another component (e.g., a classifier to classify the output data).

Some example DNNs disclosed herein include multi-MAC PEs to implement neurons. Multi-MAC PEs support operation of activation values and/or weight values of different precisions (e.g., INT8, INT4, INT2, binary, etc.). A precision or precision mode corresponds to the size of an activation value and/or weight (e.g., 8-byte, 4-byte, 2-byte, binary/1-bye). The precision of an activation and/or weight can be adjusted using the process of quantization.

The process of quantization compacts large DNN models into more compact models (e.g., to conserve resources and/or to deploy on area and/or energy constrained devices). Quantization reduces the precision of weights, feature maps, and/or intermediate gradients from a baseline flowing point sixteen/Brain floating sixteen (FP16/BF16) to integer (INT8, INT4, INT2, binary). Quantization reduces storage requirements, computational complexity, and throughput.

Another technique to improve performance and reduce energy consumption is by exploiting the property of sparsity that is present in abundance in the networks. Sparsity refers to the existence of zeros in weights and activations in DNNs. Zero valued activations in DNNs stem from the processing of the layers through activation functions, whereas zero valued weights usually arise due to filter pruning or due to the process of quantization in DNNs. These zero valued activations and weights do not contribute towards the result during MAC operations in convolutional and fully-connected layers and hence, they can be skipped during both computation and storage. Accordingly, machine learning accelerators can exploit this sparsity available in activations and weights to achieve significant speedup during compute, which leads to power savings because the same work can be accomplished using less energy, as well as reducing the storage requirements for the weights (and activations) via efficient compression schemes. Both reducing the total amount of data transfer across memory hierarchies and decreasing the overall compute time are critical to improving energy efficiency in machine learning accelerators.

As defined herein, a sparse object is a vector or matrix that includes all of the non-zero data elements of a dense vector in the same order as in the dense object. As defined herein, a dense object is a vector or matrix including all (both zero and non-zero) data elements. As such, the dense vector [0, 0, 5, 0, 18, 0, 4, 0] corresponds to the sparse vector [5, 18, 4]. As defined herein, a sparsity map (also referred to as a bitmap) is a vector that includes one-byte data elements identifying whether respective data elements of the dense vector are zero or non-zero. Thus, a sparsity map may map non-zero values of the dense vector to ‘1’ and may map the zero values of the dense vector to ‘0’. For the above dense vector of [0, 0, 5, 0, 18, 0, 4, 0], the sparsity map may be [0, 0, 1, 0, 1, 0, 1, 0] (e.g., because the third, fifth, and eighth data elements of the dense vector are non-zero). The combination of the sparse vector and the sparsity map represents the dense vector (e.g., the dense vector could be generated and/or reconstructed based on the corresponding sparse vector and the corresponding sparsity map).

Examples disclosed herein provide a DNN PE that can support MAC operation for different precisions while using a lower overhead sparsity acceleration logic using block sparsity. Block sparsity refers to each bit in a bitmap being represented as one or more particular byte sizes (e.g., binary or 1 byte, 2 bytes, 4 bytes, 8 bytes, etc.) based on whether the activations and/or weights corresponding to one or more corresponding precisions (e.g., INT1, INT2, INT4, INT8, etc.). For example, some DNN PE may include MAC circuitry that is structured to perform operations corresponding to a particular precision (e.g., INT8 or 8-byte operations). In examples when all the activation and/or weights correspond to the same precision, examples disclosed herein are able to perform operations with different precisions by grouping the different precision values into 8-byte values and adjusting the bitmap accordingly. For example, four 2-byte values can be grouped into a single 8-byte value and if any of the bitmaps of the 2-byte values is ‘1’ (e.g., meaning that the corresponding activation and/or weight value is non-zero), then the bitmap for the 8-byte value becomes ‘1.’ In this manner, 8-byte values can be feed into the MAC PE in 8-byte form (e.g., so that the MAC PE can perform the 8-byte operation), even if the input values correspond to a different precision (e.g., 2-byte precision).

However, grouping smaller precisions into a bigger precision that MAC PE is structure to operate with may cause an increase in overhead. For example, if eight binary precision values are grouped into an 8-byte precision value and only one of the eight binary values is a non-zero, then the bitmap for the 8-byte group is ‘1’ and all eight binary bytes are operated on in the MAC PE (e.g., even though 7 of the bytes are zero and would be skipped if not grouped). Accordingly, examples disclosed herein reduce overhead by leveraging the fact that MAC operation is associative and commutative by changing the order of input activations and/or weights to group all the non-zero values together prior to grouping. In this manner, the groups will less likely include both non-zero and zero values and a higher percentage of the zero values can be skipped in operation, thereby reducing overhead. To ensure that the correct weight is multiplied to the correct activation, if the order activations are adjusted, the order of the weights are adjusted in the same way and/or, if the order of the weights are adjusted, the order of the activations are adjusted in the same way.

Additionally examples disclosed herein provide a DNN with a MAC PE that leverages sparsity and multiple precisions within a single input vector or matrix. For example, instead of all input activation values of a vector corresponding to the same precision value, examples disclosed herein facilitate the use of an input activation vector and/or weight vector where the activation values/weights may correspond to different precisions (e.g., a first value corresponds to 8-byte precision, a second value corresponds to 2-byte precision, etc.). To achieve multi-precision input vectors, examples disclosed herein provide a multi-byte bitmap. As described above, a bitmap identifies which values in an activation or weight vector are zero (e.g., using a ‘0’) and which values in the activation or weight vectors are non-zero (e.g., using a ‘1’). With a multi-byte bitmap, the value in the bitmap corresponds to non-zero and precision. For example, an entry in a bitmap with a ‘0’ may correspond to a zero in the corresponding input vector, an entry in the bitmap with a ‘1’ may correspond to a non-zero 2-byte value in the corresponding input vector, an entry in the bitmap with a ‘2’ (or ‘10’ in binary) may correspond to a non-zero 4-byte value in the corresponding input vector, and an entry in the bitmap with a ‘3’ (or ‘11’ in binary) may correspond to a non-zero 8-byte value in the corresponding input vector.

To facilitate operation of the multi-precision input vectors/matrices (e.g., activation and/or weight) in the multi-MAC structure, examples disclosed herein provide a precision-based queue to ensure that the multi-MAC PE can operate according to the structured precision. For example, if a multi-MAC PE is structured to perform 8-byte operations, examples disclosed herein may include a 2 byte precision based first in first out (FIFO) register that is structured to store four 2-byte precision activations and the corresponding 2-byte precision weights. When the FIFO is full, the FIFO outputs the four 2-byte precision activations and the four 2-byte precision weights to the MAC PE to perform an 8 byte operation. Additionally, the queue may include a 4-byte based FIFO structured to store two 4-byte precision activations and corresponding weights, a single 8-byte based FIFO structured to store one 8-byte precision activation and corresponding weight, etc. In this manner, the MAC PE can perform a particular precision operation (e.g., an 8-byte operation) on activations and corresponding weights of any type of precision.

In general, implementing a machine learning (ML)/artificial intelligence (AI) system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters may be used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, training is performed until a threshold number of actions have been predicted. In examples disclosed herein, training is performed either locally (e.g., in the device) or remotely (e.g., in the cloud and/or at a server). Training may be performed using hyperparameters that control how the learning is performed (e.g., a learning rate, a number of layers to be used in the machine learning model, etc.). In some examples re-training may be performed. Such re-training may be performed in response to a new program being implemented or a new user using the device. Training is performed using training data. When supervised training may be used, the training data is labeled. In some examples, the training data is pre-processed.

Once training is complete, the model is deployed for use as an executable construct that processes an input and provides an output based on the network of nodes and connections defined in the model. The model is stored locally in memory (e.g., cache and moved into memory after trained) or may be stored in the cloud. The model may then be executed by the computer cores.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

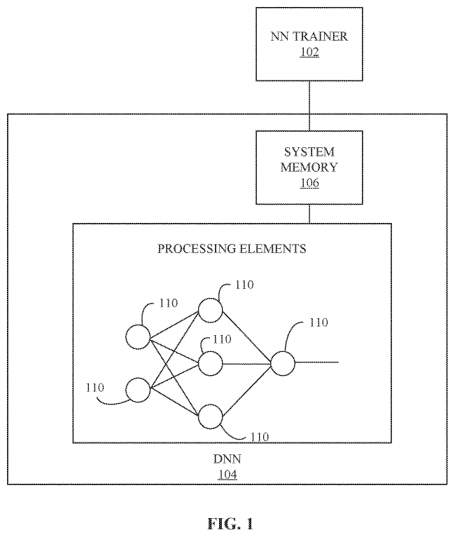

FIG. 1 is a schematic illustration of an example neural network (NN) trainer 102 to train an example DNN 104. The example DNN 104 includes an example system memory 106 and layers of example neurons (herein referred to as neurons, compute nodes, processing elements, etc.). Although the illustrated neurons 110 of FIG. 1 include six neurons in three layers, there may be any number of neurons in any type of configuration. Although the example of FIG. 1 is described in conjunction with the DNN 104, examples disclosed herein may be utilized in any AI-based system or model that includes weights.

The example NN trainer 102 of FIG. 1 trains the DNN 104 by selecting weights (e.g., formed in a vector or matrix) for each of the neurons 110. Initially, the DNN 104 is untrained (e.g., the neurons are not yet weighted with a mean and deviation). To train the DNN 104, the example NN trainer 102 of FIG. 1 uses training data (e.g., input data labeled with known classifications and/or outputs) to configure the DNN 104 to be able to predict output classifications for input data with unknown classifications. The NN trainer 102 may train a model with a first set of training data and test the model with a second set of the training data. If, based on the results of the testing, the accuracy of the model is below a threshold, the NN trainer 102 can tune (e.g., adjust, further train, etc.) the parameters of the model using additional sets of the training data and continue testing until the accuracy is above the threshold. After the NN trainer 102 has trained the DNN 104, the example NN trainer 102 stores the corresponding means and deviations for the respective neurons 110 in the example system memory 106 of the example DNN 104. The example NN trainer 102 may be implemented in the same device as the DNN 104 and/or in a separate device in communication with the example DNN 104. For example, the NN trainer 102 may be located remotely, develop the weight data locally, and deploy the weight data (e.g., a vector/matrix of weights to be implemented by corresponding neurons 110) to the DNN 104 for implementation (e.g., application of the eights to activations by a MAC operation).

The example DNN 104 of FIG. 1 includes the example system memory 106. The example system memory 106 stores the generate weights (e.g., weight vectors or matrices) for the example NN trainer 102 in conjunction with a particular neuron. During implementation, the DNN 104 accesses the stored weight vectors and transmits to the corresponding neurons 110 to be applied to activation data.

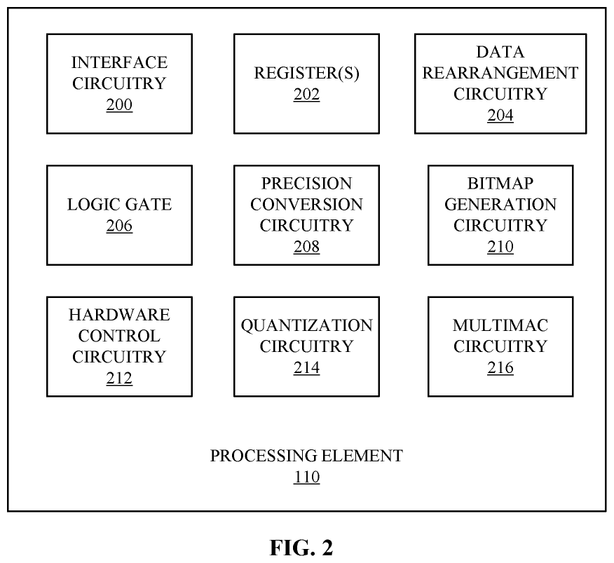

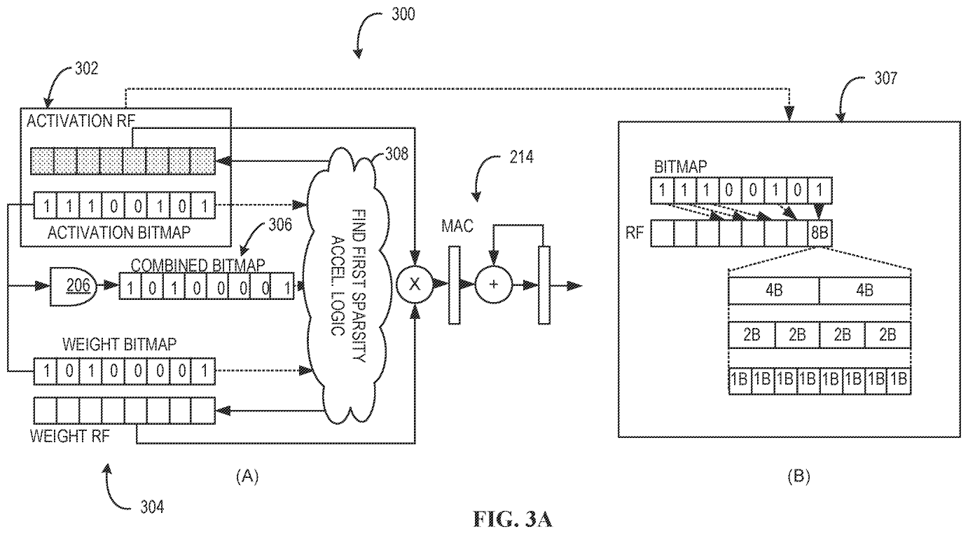

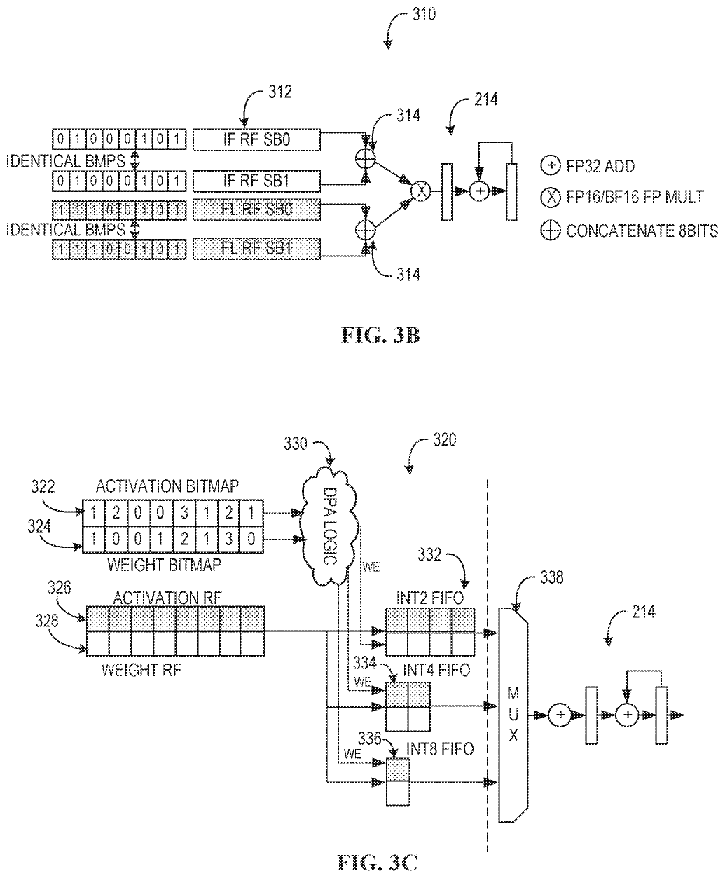

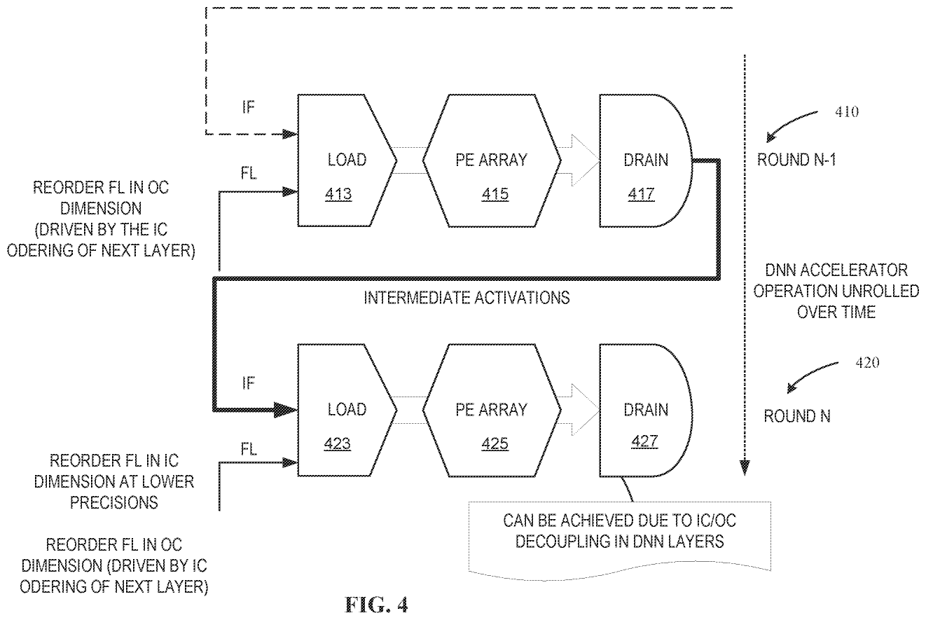

The example neurons 110 of FIG. 1 are structured in the layers. As further described below, the neurons 110 are implemented by processing elements including, or in communication with, MAC processing elements. The example neurons 110 receive input/activation data (e.g., structured in a vector/matrix), apply weights (e.g., structured in a vector/matrix) to the input/activation data to generate outputs (e.g., structured as a vector/matrix). The MAC PE may perform a multiplication and accumulation process to the activations and corresponding weights. As further described below, the neurons 110 are able to apply weights to activations regardless of the precision(s) (e.g., INT8, INT4, INT2, binary, etc.) of the weights and/or activations. Additionally, the neurons 110 are able to reduce overhead and conserve processing resources by leveraging sparsity of the weights and/or activations. An example structure of one of the neurons 110 is further described below in conjunction with FIGS. 2-3C.

FIG. 2 is a block diagram of one of the example processing elements (e.g., neuron) 110 of FIG. 1. The example processing element 110 includes example interface circuitry 200, example register(s) 202, example data rearrangement circuitry 204, an example logic gate 206, example precision conversion circuitry 208, example bitmap generation circuitry 210, example hardware control circuitry 212, example quantization circuitry 214, and example MultiMAC circuitry 216.

The example interface circuitry 200 of FIG. 2 obtains (e.g., receives, accesses, etc.) weights (e.g., a vector/matrix of weights) to be applied to input data (e.g., a vector/matrix of activations) from the example system memory 106. As described above, the weights are based on training to configure the DNN 104 to perform a task (e.g., classify input data). Additionally, the example interface circuitry 200 obtains (e.g., receives, accesses, etc.) the input data (e.g., a vector/matrix of activations) from another component and/or another processing element (e.g., from another processing element 110). Additionally, the example interface circuitry 200 outputs (e.g., transmits) the output data after the weights have been applied (e.g., using a multiply and accumulate process) to input activations. Additionally, the example interface circuitry 200 obtain additional data corresponding to the input data, weights, and/or output data. For example, if the input data, weight data, and/or output data includes corresponding bitmap(s), the example interface circuitry 200 obtains the corresponding bitmap(s). In some examples, the interface circuitry 200 includes a first interface to obtain weights, a second interface to obtain the input data, and a third interface to output the output data. In some examples, the interface circuitry 200 can include a single interface to obtain weights, obtain activations, and transmit output data. Additionally or alternatively, the interface circuitry 200 may include any number of interfaces to obtain and/or output data.

The example register(s) 202 of FIG. 2 are storage, buffers, memory, etc. to store data. For example, the register(s) 202 may include a first register to store obtained weights and, in some examples, a corresponding weight bitmap and a second register to store obtained input data and, in some examples, a corresponding activation bitmap. In some examples (e.g., when the bitmap is a multi-byte bitmap corresponding to different precisions of the input activation and/or weights), the register(s) 202 may include different registers (e.g., FIFO buffers) that correspond to different precisions. In such example, each register is sized according to (a) the precision and (b) the structure of the MultiMAC circuitry 216. For example, if the MultiMAC circuitry 216 is structured to perform 8-byte operations, the register(s) 202 may include a 1-byte based register to store eight 1-byte activations and eight 1-byte weights, a 2-byte based register to store four 2-byte activations and four 2-byte weights, a 4-byte based register to store two 4-byte activations and two 4-byte weights, and/or a single 8-byte register to store one 8-byte activation and one 8-byte weight. In this manner, when any one of the registers is full, the corresponding register 202 can output 8-bytes worth of activation data and 8-bytes worth of bitmap data to the MultiMAC circuitry 216 to perform an 8-byte operation. Operation of the register(s) 202 is further described below in conjunction with FIG. 3C.

The example data rearrangement circuitry 204 of FIG. 2 reduces overhead by rearranging the non-zero values of an input activation vector (or matrix) and/or the weight vector (or matrix) to group the non-zero values together. For example, if, as further described below, the precision conversion circuitry 208 groups four 2-byte values into a single 8-byte value and only one of the 2-byte values is non-zero, then the corresponding bitmap value for the grouped 8-byte value will be 1 (which means the operation will not be skipped) even though most of the 8-byte value is non-zero. Accordingly, the example data rearrangement circuitry 204 rearranges activation values and/or weights so that non-zero values are grouped together. In this manner, the probability of having groups values that either correspond to non-zero values or zero values is increased, thereby reducing the overhead and conserving processing resources and time.

Additionally or alternatively other components may be included and/or used to replace the data rearrangement circuitry 204 to ensure that non-zero data are grouped together. For example, training circuitry can train the network for structured sparsity so that consecutive element to be accumulated (e.g., either in the input data or in a FX, FY filter window dimension) that share a bit to have all 0s or all 1s to generate grouped non-zero and zero data. Additionally or alternatively, the example quantizer 214 can quantizes activation data and/or weight data to have spatial locality adjustment activation points that have the same value (e.g., with 0s adjacent and grouped together), which can be exploited for a FX, FY filter window convulsion case.

However, if activations are rearranged, then the corresponding weights have to be rearranged in the same manner to ensure that the correct weight is applied to the correct activation value. Likewise, if the weights are rearranged, activations have to be rearranged in the same manner. The data rearrangement circuitry 204 of FIG. 2 can rearrange activation data during run-time (e.g., after the activation is obtained). Additionally or alternatively, the data rearrangement circuitry 204 can rearrange weight data during run-time and/or before run-time (e.g., because the weights are known before input data is applied). In some examples, the data rearrangement circuitry 204 may process the weights before runtime to determine how beneficial it would be to reorder the weights and/or to reorder a portion of the weights (e.g., based on a reduction in overhead). Additionally, the data rearrangement circuitry 204 may process the activations during run time to determine how beneficial it would be to reorder the activations and/or to reorder a portion of the activations. In this manner, the data rearrangement circuitry 204 can determine whether to rearrange the activations, rearrange the weights, and/or rearrange a portion of the activations and rearrange a second mutually exclusive portion of the weights.

The example logic gate 206 of FIG. 2 is an “AND” logic gate. When the bitmaps corresponding to an activation vector/matrix and a weight vector/matrix are obtained, the example logic gate 206 performs a logic “AND” function to the bitmaps to determine which operations (e.g., multiple and accumulate) should be performed and which operations can be skipped. For example, if the bitmap of an activation or a weight is 0 then multiplication by 0 will result in a zero. Accordingly, such an operation can be skipped to converse resources. The AND function will only output a ‘1’ when both the weight bitmap and the activation bitmap are both ‘1’ (e.g., corresponding to the weight and the activation being non-zero activations). Accordingly, when the output of the logic gate 206 is a ‘0’, the corresponding weight and activation can be discarded and the multiplication is not performed by the MultiMAC circuitry 216 (e.g., because the result will be zero and not add anything to the accumulation). When the output of the logic gate 206 is ‘1’, the corresponding weight and activation values are provided to the MultiMAC circuitry 216 to perform the multiplication.

The example precision conversion circuitry 208 of FIG. 2 groups smaller precision values (e.g., from an activation vector and/or a weight vector) into larger precision values that the MultiMAC circuitry 216 is structured to operate at. For example, if the MultiMAC circuitry 216 is structured to perform 8-byte operations, the precision conversion circuitry 208 can group eight 1-byte values (e.g., activation values and/or weight values) into a signal 8-byte value, four 2-byte values into a single 8-byte value, and/or four 2-byte values into a single 8-byte value.

The example bitmap generation circuitry 210 of FIG. 2 converts the corresponding bitmap to match the groups. For example, if the precision conversion circuitry 208 converts four 2-byte values into a single 8 byte value, the bitmap generation circuitry 210 determines if the corresponding bitmaps for any one of the four two-byte values is non-zero. If one of the values of the corresponding bitmap is non-zero (e.g., ‘1’), the bitmap generation circuitry 210 generates a bitmap value for the single 8-byte value to be non-zero (e.g., ‘1’). If all of the bitmaps for the four 2-byte values are zero, then the bitmap generation circuitry 210 generates a bitmap value for the single 8-byte value to be zero. In this manner, the bitmap generation circuitry 210 converts the four bitmap values corresponding to the four 2-byte values into a bitmap value for the single 8-byte value. In some examples, the bitmap generation circuitry 210 processes the activation values (as opposed to the corresponding bitmaps) to generate the bitmap of the grouped activation and/or weight values.

The example bitmap generation circuitry 210 of FIG. 2 may also generate a multi-bit bitmap (also referred to as a block for activation data and/or weights. The multi-bit bitmap is a bitmap that can represent different precision values by using more than one bit per entry. For example, instead of utilizing a ‘1’ for a non-zero entry of a dense vector/matrix and a ‘0’ entry for a zero entry of a dense vector/matrix, the example bitmap generation circuitry 210 can determine the precision of the non-zero entries of the dense vector/matrix and utilize a number corresponding to the precision. For example, the bitmap generation circuitry 210 may utilize a ‘1’ to represent a binary (e.g., 1-byte) non-zero value, ‘2’ to represent a 2-byte non-zero entry, a ‘3’ to represent a 4-byte non-zero entry, etc. In some example the example bitmap generation circuitry 210 is located outside of the example PE 110 (e.g., in a different location of the DNN) and can generate the bitmaps prior to the data entering the process element 110.

The example hardware control circuitry 212 of FIG. 2 controls the hardware of the processing element 110 to facilitate the transmission of activations and/or weight values to the MultiMAC circuitry 216. For example, the hardware control circuitry 212 may obtain an output of the logic gate 206 identifying which activation values to apply corresponding weights (e.g., because the value from the output of the logic gate 206 corresponding to those activations and weights is non-zero) and which activations and corresponding weights can be skipped (e.g., because the value form the output of the logic gate 206 corresponding to those activations and weights is zero, meaning the result of a multiplication would be zero and therefore can be skipped. Additionally, to facilitate multiple different precisions within a weight vector/matrix and/or activation vector/matrix, the processing element 110 may include different precision-based registers and a multiplexer to facilitate the order of when weights values are applied to corresponding activation values of the stored weight and activation vectors/matrices. Accordingly, the hardware control circuitry 212 can determine which precision-based buffers to store activation and/or weight data into, when to output the data from the precision-based buffers, and how to control the MUX to ensure that the data output from the precision-based buffers are output to the MultiMAC circuitry 216 at the correct time. The example hardware control circuitry 212 is further described below in conjunction with FIG. 3C.

The example quantization circuitry 214 of FIG. 2 activations and/or weights into two or more independent precision-based sets. One set can be quantized to higher precision (e.g., INT8), while another set will be quantized to lower precision (q). For example, the example quantization circuitry 214 forces p % of the block values to INT4 (e.g., q=4) and (1−p) % of the block values to INT8. The selected precisions and/or percentages may be based on user and/or manufacturer preferences. In some examples, the example quantization circuitry 214 partitions the block into two sets by sorting the values by absolute magnitude. In some examples, the example quantization circuitry 214 utilize a dynamic multiprecision data format to assign lower precisions to the weights when possible. The partitioning above ensures p % of the weights are at most at the lower precision (e.g. at most INT4). In some examples, the example quantization circuitry 214 may use more than 2 quantization levels (e.g. INT2+INT4+INT8).

The block size ([l,w], where l is length and w is width), percentage of low precision values within a block (p), and the number of bits allocated for low precision values (q) may affect performance. For example, larger block sizes may result in better performance (but more overhead) than smaller block sizes, smaller p values may result in better accuracy (but more overhead) than larger p values, and larger q values may result in better accuracy (but more overhead) than smaller q values.

In some examples, the hardware of the processing element 110 can take advantage of the mix precision pattern in the weight matrix at runtime to speed up computation. In addition, overhead due to the bitmap masks can be reduced this way. For example, for the case where p=50% and INT4/INT8 are used low and high precision, for the worse case, the average number of bit used (value+mask) per weight value is 8 bit compared to the case where the average number of bit used is 10 bit for INT8 quantization.

The example MultiMAC circuitry 216 of FIG. 2 applies weights to corresponding activations. For example the MultiMAC circuitry 216 multiplies weights to activations and accumulates (e.g., sums) the results of the multiple products. The MultiMAC circuitry 216 may be structured to perform a particular precision operation (e.g., 8-byte operations). However, as described above, the input data and/or weights can be grouped and/or stored according to precision so that when the activation data and/or weights are input into the MultiMAC circuitry 216 they are input using the precision that the MultiMAC circuitry 216 is structured to perform. The example MultiMAC circuitry 216 is further described below in conjunction with FIGS. 3A-3C.

FIG. 3A illustrates example circuitry 300 included the example processing element 110 of FIGS. 1 and/or 2 which the MultiMAC circuitry 216 works with the sparsity acceleration logic within the PE 110. The example circuitry 300 includes the example logic gate 206 and the example MultiMAC circuitry 216 of FIG. 2. The example circuitry 300 further includes an example input activation vector/matrix and corresponding activation bitmap 302, an example weight vector/matrix and corresponding bitmap, an example combined bitmap 306, and example sparsity logic 308.

The example activation vector/matrix and corresponding activation bitmap 302 of FIG. 3 and the example weight vector/matrix and corresponding weight bitmap 304 are stored in the example register(s) 202 of FIG. 2. As shown in the example illustration 307, the bitmap includes a ‘1’ to identify that a value of a dense vector/matrix at the corresponding location is non-zero and includes a ‘0’ to identify that the value of the dense vector at the corresponding location is zero. The activation data is sparsity data that includes the value of the non-zero elements of the dense vector. Accordingly, the activation vector is a compressed version of the dense vector where the bitmap can be used to reconstruct the dense vector using the condensed sparce activation vector. As explained above in conjunction with FIG. 1. Each 8-byte value of the activation vector and/or weight vector may represent groups of smaller precision values, as shown in the example illustration 307.

The example logic gate 206 of FIG. 3A performs a logic AND with the activation bitmap 302 and the weight bitmap 304 to generate the example combined bitmap 306. As described above, the combined bitmap 306 corresponds to the weight values and activation values that will correspond to a non-zero result after multiplication. For example, each ‘1’ in the combined bitmap 306 corresponds to a weight and corresponding activation that, when multiplied, result in a non-zero value and each ‘0’ in the combined bitmap 306 corresponds to a weight and corresponding activation that, when multiplied, result in a zero value (e.g., and therefor can be skipped and/or discarded to conserve resources). The example sparsity logic 308 (e.g., implemented by example hardware control circuitry 212 of FIG. 2) obtains the combined bitmap 306 to determine (A) which activation and corresponding weight values to output to the MultiMAC circuitry 216 (e.g., when the corresponding combined bitmap value is ‘1’) for multiplication and accumulation and (B) which activation and corresponding weight values to skip or discard (E.g., when the corresponding combined bitmap value is ‘0’).

Sparsity logic (e.g., find-first sparsity logic) 308 of FIG. 3A may be implemented by the example hardware control circuitry 212 of FIG. 2 works with compressed data (e.g., zero-value compressed). The zero and non-zero positions in the activation and weight data are represented by a bit in the bitmap in a compressed mode. The non-zero values are compressed and kept adjacent to one another in one of the registers 202 of FIG. 2. In the single precision MAC, each byte represents one activation or filter point and is represented by one bit in the bitmap. The same logic can be kept intact and easily be applied for MultiMAC by introducing the concept of block sparsity where each bit in bitmap can either represent 1, 2, 4, or 8 ICs based on whether UINT8/INT8, UINT4/INT4, UINT2/INT2, or binary mode (BIN), respectively, are active. Only in the case when all ICs or the entire byte is 0, will a 0 be placed in the bitmap (e.g., otherwise the value will be a 1). This coarse-granular approach to maintaining sparsity information for lower precision modes may have pros and cons. For example, one advantage is that the same sparsity encoder that operates at a byte-level may be used, which decreases the overall impact on DNN accelerator area and energy. Another advantage is that the storage and processing overhead of the bitmap for each IC is also reduced at lower precisions. A downside of block sparsity, however, may be that it keeps track of sparsity at a much coarser-granularity and therefore reduces the maximum potential speedup that can be achieved through fine-granular tracking

FIG. 3B shows example circuitry 310 in which floating point (FP16/BF16) execution occurs within the PE 110. The example circuitry 310 includes the example MultiMAC circuitry 216 of FIG. 2, example subbanks 312 and example concatenating circuitry 314. In addition to the integer-based MultiMAC, support may be provided for floating point execution within the PE. Although this support may involve a completely separate floating point MAC (FPMAC, e.g., separate from the MultiMAC, is not shared), the existing sparsity logic may be readily used for floating point execution. Accordingly, examples disclosed herein may be utilized in conjunction with floating point operations.

Because each RF subbank (SB) 312 (e.g. the input feature (IF) register file (RF) SBs corresponding to the activations and the filter (FL) RF SBs corresponding to the weights) has sixteen 1-byte entries and each bitmap sublane has a bit corresponding to each byte in the RF subbank, the example concatenating circuitry 314 can create a single 16 byte floating point (FP16/BF16) operand by concatenating 1B each from two RF subbanks, as shown. In some examples, the sparsity logic works “out of the box” without any additional changes. The circuitry 310 ensures that during zero value suppression, the higher and lower bytes of a single BF/FP16 operand are not independently encoded. In one example, a zero is only assigned to a byte when both the upper and the lower halves of the operand are zero (e.g., when the entire activation is zero), thereby ensuring that the bitmap fed in the two bitmap sublanes corresponding to the upper and lower bytes of the FP operand are exactly the same. The reuse of sparsity logic for the FP case reduces the overall overhead of sparsity.

FIG. 3C illustrates example circuitry 320 that may be implemented by the example PE 110 to support activations and/or weight vectors or matrices that include values corresponding to different precisions. The example circuitry 320 includes an example multi-bit activation bitmap 322, an example multi-bit weight bitmap 324, an example activate sparse vector 326, an example weight sparce vector 328, example dynamic precision acceleration (DPA) logic 330 (which may be implemented by the hardware control circuitry 212 and/or the quantization circuitry 214 of FIG. 2), example precision-based buffers 332, 334, 336, an example multiplexer (MUX) 338, and the example MultiMAC circuitry 216 of FIG. 2.

As described above, the example bitmap generation circuitry 210 of FIG. 2 can generate the example bitmaps 322, 324 to be a multi-bit bitmap corresponding to a dense activation vector and a dense weight bitmap. In the example of FIG. 3C, a ‘0’ in the bitmaps 322, 324 corresponds to a zero value in a corresponding location of a dense vector, a ‘1’ in the bitmaps 322, 324 corresponds to a 2-byte value in the corresponding location of the dense vector (e.g., the 2-byte value included in a corresponding location of the activation sparse vector 326 (or matrix) or weight sparse vector 328 (or matrix)), a ‘2’ in the bitmaps 322, 324 corresponds to a 4-byte value in the corresponding location of the dense vector (e.g., the 4-byte value included in a corresponding location of the activation sparse vector 326 or weight sparse vector 328), and a ‘3’ in the bitmaps 322, 324 corresponds to an 8-byte value in the corresponding location of the dense vector (e.g., the 8-byte value included in a corresponding location of the activation sparse vector 326 or weight sparse vector 328). Alternatively, the values of the bitmap may correspond to different and/or additional precisions.

The example circuitry 320 includes the example precision-based buffers 332, 334, 336. As further described below, the example DPA logic 330 stores activation values and corresponding weight values in one of the precision-based buffers 332, 334, 336 based on the precisions of the activation and/or weight values. The precision-based buffers 332, 334, 336 are sized according to the precision to ensure that the precision values are grouped to be transmitted to the MultiMAC circuitry 216 via the MUX 338 as a grouped value that corresponds to the structure of the example MultiMAC circuitry 216. For example, the MultiMAC circuitry 216 of FIG. 3C is structured to perform 8-byte operations. Accordingly, the buffers 332 are sized to hold 8 bytes of activation data and 8 bytes of weight data. For example, the INT2 buffer 332 is structured to store four 2-byte activation values (e.g., corresponding to 8 bytes of activation data) and four 2-byte weight values (e.g., corresponding to 8 bytes of weight data), the INT4 buffer 332 is structured to store two 4-byte activation values (e.g., corresponding to 8 bytes of activation data) and two 4-byte weight values (e.g., corresponding to 8 bytes of weight data), and the INT2 buffer 332 is structured to store one 8-byte activation values (e.g., corresponding to 8 bytes of activation data) and one 8-byte weight values (e.g., corresponding to 8 bytes of weight data). In this manner, when any one of the buffers 332, 334, 336 are full, all of the contents can be output to the MultiMAC circuitry 216 via the MUX 338 so that the MultiMAC circuitry 216 obtains two 8 bytes pieces of data and performs an 8-byte operation (e.g., multiplication and accumulation).

In operation, the example DPA logic 330 of FIG. 3 may be implemented by the example logic gate 206, the example hardware control circuitry 212, and/or the example quantization circuitry 214 of FIG. 2. The example DPA logic 330 processes the example bitmaps 322, 324 to determine which precision-based buffer 332, 334, 336 to input the corresponding weight and activation value into. For example, the logic gate 206 performs a logic AND to values of the example activation bitmap 322 and the example weight bitmap 324 to generate a combined bitmap that can be used to determine which values to apply to the MultiMAC circuitry 216 and which values can be skipped (e.g., because the output of the AND process results in a zero value), as further described above. For example, the DPA logic 330 determines that the first activation value will be skipped because AND(1,0) will result in a zero. Thus, a multiplication of the activation value and the weight will be zero, so this operation can be skipped and the first value in the sparse activation vector (e.g., the 2-byte value) is discarded. The DPA logic 330 will not skip the second activation value because AND(2, 3) will not result in a zero value. Accordingly, the DPA logic 330 selects the corresponding activation value (e.g., the second activation value from the sparse activation value) and the corresponding weight value (e.g., the first weight value from the sparse weight value) and determines which buffer 332, 334, 336 to store the selected values into.

The example DPA logic 330 selects the buffer 332, 334 336 based on the precisions of the activation value and the precision value. For example, if the DPA logic 330 determines that the precision of the activation and the corresponding weight is the same, the DPA logic 330 stores the activation and the corresponding weight in the precision-based buffer that correspond to the determined precision. If the DPA logic 330 determines that the precision of the activation is different than the precision of the weight, the DPA logic 330 selects the higher precision of the activation or the weight and stores the activation and the corresponding weight in the precision-based buffer that corresponds to the higher precision. For the activation and/or weight of the lower precision, zeros can be added to the activation and/or weight to fill the corresponding space in the buffer.

The example DPA logic 330 of FIG. 3C further monitors the buffers 332, 334, 336 to determine when any one of the buffers is full. In this manner, the example DPA logic 330 can output one or more signals to the MUX 338 (e.g., to one or more select lines of the MUX 338). The MUX 338 is coupled to the output of each of the buffers 332, 334, 336. The MUX 338 includes one or more select inputs coupled to the hardware control circuitry 212 so that the hardware control circuitry 212 can control which data is output to the MultiMAC circuitry 216 for multiplication and accumulation based on the DPA logic 330 (e.g., when the corresponding buffer is full). In some examples the MUX 338 includes multiple MUXs. In some examples, if one or more of the buffers 332, 334, 336 is not full after a threshold amount of time (e.g., tracked by a timer of the hardware control circuitry 212), then the example DPA logic 330 fills the empty slots in the buffers 332, 334 with zero values to flush out the data stored in the example buffers 332, 334. Additionally, as described above in conjunction with FIG. 2, the example quantization circuitry 214 may quantize the activation data and/or weight data to structure the data into one or more different precisions to decrease the overhead of the multi-precision activation and/or weight data.

In some examples, there may be a mismatch between the left side of the dashed line and the right side of the dashed line in the example of FIG. 3C. For example, the left side can produce too few samples (e.g., when the activations and/or weights are very sparse (e.g., include a lot of zeros) which leads to many zero multiplications that are discarded) for the right side of the dotted line to consume, leading to stalls. In such examples, the clock rate of the left side may be set to a faster clock rate then the clock rate on the right side. Additionally or alternatively, parallel DPA logic can be utilized to scan bitmaps in parallel to generate more samples for the right side to consume. In some examples, the DPA logic 330 can adjust clock rates and/or enable parallel processing based on (a) determining the sparsity of the activation and/or weight data) and/or (b) identifying stalls.

FIG. 4 illustrates two neighboring DNN example layers 410 and 420 including rearranged weight vectors/matrices, in accordance with various embodiments. The layer 410 is adjacent to and precedes the layer 420 in the DNN. The example layers 410 and 420 may be convolutional layers in the DNN. An intermediate activation data 430 is output from the first example layer 410 to the second example layer 420.

The layer 410 includes a load 413, a PE array 415, and a drain 417. The load 413 loads an input feature map and filters of the layer 410 into the PE array 415. The PE array 415 performs MAC operations. The drain 417 extracts the output of the PE array 415, which is the output feature map of the example layer 410. The intermediate activation 430 is an output feature map of the example layer 410 that is transmitted to the example layer 420. The output activations 430 of the example layer 410 are utilized as an input feature map of the example layer 420.

The example layer 420 of FIG. 4 includes an example load 423, an example PE array 425, and an example drain 427. The example load 423 loads the input feature map and filters of the example layer 420 into the example PE array 425. The example PE array 425, which may include ant of the components of the PE 110 of FIGS. 1-3C, performs MultiMAC operations on the input feature map, filters, and activation 430. The filters may include one or more weight vectors that have been rearranged to keep non-zero values together and/or near each other. In some examples, all the weights in the filters are rearranged for keeping non-zero values together and/or near each other. The filters may be used as a unit in the process of grouping non-zero values. For example, a weight matrix of the filter is converted to a weight vector. Additionally or alternatively, a portion of a filter is used as a unit.

As the order of weights changed, the order of elements in the input feature map may also need to be changed. This is because input feature map and weights come into the DNN layer as a pair so if the indices of the weights are changed, the same change needs to be made to the elements in the input feature map. The change to the order of the elements in the input feature map can be done by the previous layer, i.e., the layer 410, generates the input feature map of the layer 420 in an order that matches the rearranged weight vector. As the ordering of input feature map and output feature map in a DNN layer can be independent and hence, the input feature map and output feature map can be ordered in different ways. This decoupling allows a change to the order of the output feature map of the example layer 410 (i.e., the input feature map of the example layer 420) to match the rearranged weight vector in the example layer 420.

In some embodiments, an activation vector 430 (or matrix) of FIG. 4 is rearranged based on the bitmap of the rearranged weight vector so that the input feature map of the example layer 420 (e.g., the output activations 430 of the example layer 410) will be consistent with rearranged filters of the example layer 420. A weight vector (or matrix) in the filters of the example layer 410 may also be rearranged based on the bitmap of the rearranged weight vector to offset the rearrangement of the weight vector of the example layer 420. As the weight vector of the example layer 410 is rearranged, the output feature map of the example layer 410 and the input feature map of the example layer 420 will be rearranged accordingly. Therefore, during the MultiMAC operations of the PE array 415, the impact of the rearrangement on the output feature map of the example layer 420 will be eliminated so that the output feature map of the example layer 420 will still be compatible with MultiMAC operations in the next layer, i.e., the layer following the example layer 420. In embodiments where the example layer 410 is the first layer of the DNN, the weight and activations can be rearranged offline, e.g., by a compiler, before loaded into the example PE array 415.

In the examples, the reordering pattern of weights and/or activations may be unique for each layer. Accordingly, weights (e.g., if the activations were reordered) and/or activations (if the weights were reordered) may need to be feed into layers at a different orders corresponding to the reordering patterns of the layers. In some examples, the example PE 110 stores a single dense vector (or matrix) for the highest structured precision and then rearranges the dense vector on the fly using hardware. In some examples, only particular values are rearranged.

While an example manner of implementing the PE 110 of FIG. 1 is illustrated in FIGS. 1-4, one or more of the elements, processes and/or devices illustrated in FIGS. 1-4 may be combined, divided, re-arranged, omitted, eliminated and/or implemented in any other way. Further, the example interface circuitry 200, the example register(s) 202, the example data rearrangement circuitry 204, the example logic gate 206, the example precision conversion circuitry 208, the example bitmap generation circuitry 210, the example hardware control circuitry 212, the example quantization circuitry 214, the example MultiMAC circuitry 216, the example find first sparsity acceleration logic 308, the example concatenating circuitry 314, the example DPA logic 330, the example buffers 332, 334, 336, the example MUX 338, and/or, more generally, the example PE 110 of FIGS. 1-4 may be implemented by hardware, software, firmware and/or any combination of hardware, software and/or firmware. Thus, for example, any of the example interface circuitry 200, the example register(s) 202, the example data rearrangement circuitry 204, the example logic gate 206, the example precision conversion circuitry 208, the example bitmap generation circuitry 210, the example hardware control circuitry 212, the example quantization circuitry 214, the example MultiMAC circuitry 216, the example find first sparsity acceleration logic 308, the example concatenating circuitry 314, the example DPA logic 330, the example buffers 332, 334, 336, the example MUX 338, and/or, more generally, the example PE 110 of FIGS. 1-4 could be implemented by one or more analog or digital circuit(s), logic circuits, programmable processor(s), programmable controller(s), graphics processing circuitry(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example interface circuitry 200, the example register(s) 202, the example data rearrangement circuitry 204, the example logic gate 206, the example precision conversion circuitry 208, the example bitmap generation circuitry 210, the example hardware control circuitry 212, the example quantization circuitry 214, the example MultiMAC circuitry 216, the example find first sparsity acceleration logic 308, the example concatenating circuitry 314, the example DPA logic 330, the example buffers 332, 334, 336, the example MUX 338, and/or, more generally, the example PE 110 of FIGS. 1-4 is/are hereby expressly defined to include a non-transitory computer readable storage device or storage disk such as a memory, a digital versatile disk (DVD), a compact disk (CD), a Blu-ray disk, etc. including the software and/or firmware. Further still, the example PE 110 of FIGS. 1-4 may include one or more elements, processes and/or devices in addition to, or instead of, those illustrated in FIGS. 1-4, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

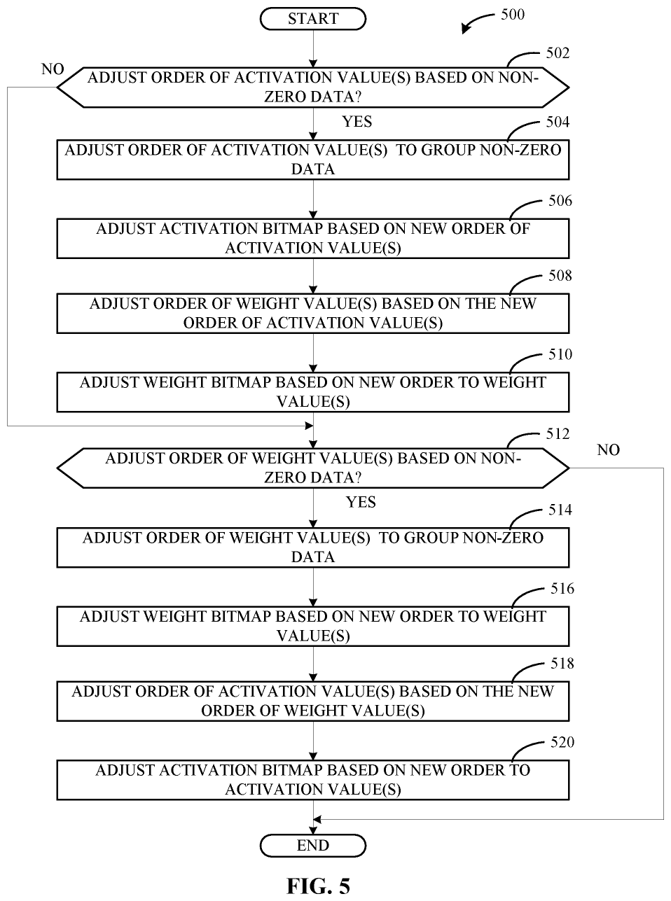

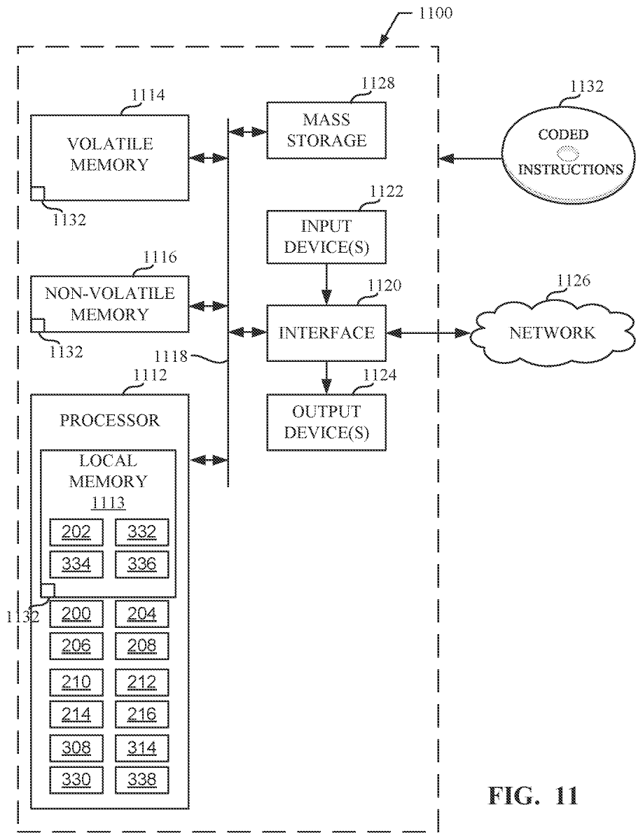

Flowchart representative of example hardware logic, machine readable instructions, hardware implemented state machines, and/or any combination thereof for implementing the example PE 110 of FIGS. 1-4 are shown in FIGS. 5-10. The machine readable instructions may be one or more executable programs or portion(s) of an executable program for execution by a computer processor such as the processor 1112 shown in the example processor platform 1100 discussed below in connection with FIG. 11. The program may be embodied in software stored on a non-transitory computer readable storage medium such as a CD-ROM, a floppy disk, a hard drive, a DVD, a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowchart illustrated in FIGS. 5-10, many other methods of implementing the example PE 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5-10 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions 500 which may be executed to implement any one of the components of the processing elements 110 of FIGS. 1-3C to adjust weights and/or activations values of weight vector/matrix and/or an activation vector/matrix to group non-zero values together. As described above, grouping non-zero values reduces the overhead of the activations and/or weights when lower precision values are grouped into a higher precision value. Although the instructions 500 are described in conjunction with the example processing element 110 of FIGS. 1-3C, the instructions 500 may be described in conjunction with any neuron in any type of neural network or other AI-based model using any type of data (e.g., input data or activations).

At block 502, the example data rearrangement circuitry 204 determines whether to adjust the order of the activation value(s) or a portion of the activation values based on the non-zero data. For example, the data rearrangement circuitry 204 may process the activation values and/or weight values to determine how to minimize the overhead based on the order of the non-zero values of the activation vector and/or the weight vectors. In some examples, the data rearrangement circuitry 204 may decrease overhead by rearranging the activations, rearranging the weights, and/or rearranging a first portion of the weights and a second mutually exclusive portion of the activations.

If the example data rearrangement circuitry 204 determines the order of the activations or a portion of the activations should not be adjusted based on the non-zero data (block 502: NO), control continues to block 512. If the example data rearrangement circuitry 204 determines the order of the activations or a portion of the activations should be adjusted based on the non-zero data (block 502: YES), the example data rearrangement circuitry 204 adjusts the order of the activation values or a portion of the activation values to group non-zero data together (e.g., block 504). At block 506, the example bitmap generation circuitry 210 adjusts the activation bitmap based on the new order of the activation values. For example, if an activation value is moved 5 spots forward in the activation vector, the corresponding bitmap value is likewise move forward in the activation bitmap vector.

At block 508, the example data rearrangement circuitry 204 adjusts the order of the weight value(s) based on the new order of the activation value(s). For example, if an activation value is moved 5 spots forward in the activation vector corresponding to a new location of the dense activation vector, the corresponding weight value is likewise moved forward in the weight vector so that the same weight is applied to the same activation. At block 510, the example bitmap generation circuitry 210 adjusts the weight bitmap based on the new order of the weight values. For example, if a weight value is moved 5 spots forward in the weight vector, the corresponding bitmap value is likewise move forward in the weight bitmap vector.

At block 512, the example data rearrangement circuitry 204 determines whether to adjust the order of the weight value(s) or a portion of the weight values based on the non-zero data. If the example data rearrangement circuitry 204 determines the order of the weights or a portion of the weights should not be adjusted based on the non-zero data (block 512: NO), control continues to block 512. If the example data rearrangement circuitry 204 determines the order of the weights or a portion of the weights should be adjusted based on the non-zero data (block 512: YES), the example data rearrangement circuitry 204 adjusts the order of the weight values or a portion of the weights values to group non-zero data together (e.g., block 514). At block 516, the example bitmap generation circuitry 210 adjusts the weight bitmap based on the new order of the weight values. For example, if an weight value is moved 5 spots forward in the weight vector, the corresponding bitmap value is likewise move forward in the weight bitmap vector.

At block 518, the example data rearrangement circuitry 204 adjusts the order of the activation value(s) based on the new order of the weight value(s). For example, if an weight value is moved 5 spots forward in the weight vector corresponding to a new location in the dense weight vector, the corresponding activation value is likewise move forward in the activation vector to ensure that the moved weight is applied to the same activation. At block 520, the example bitmap generation circuitry 210 adjusts the activation bitmap based on the new order of the activation values. For example, if an activation value is moved 5 spots forward in the activation vector, the corresponding bitmap value is likewise move forward in the activation bitmap vector.

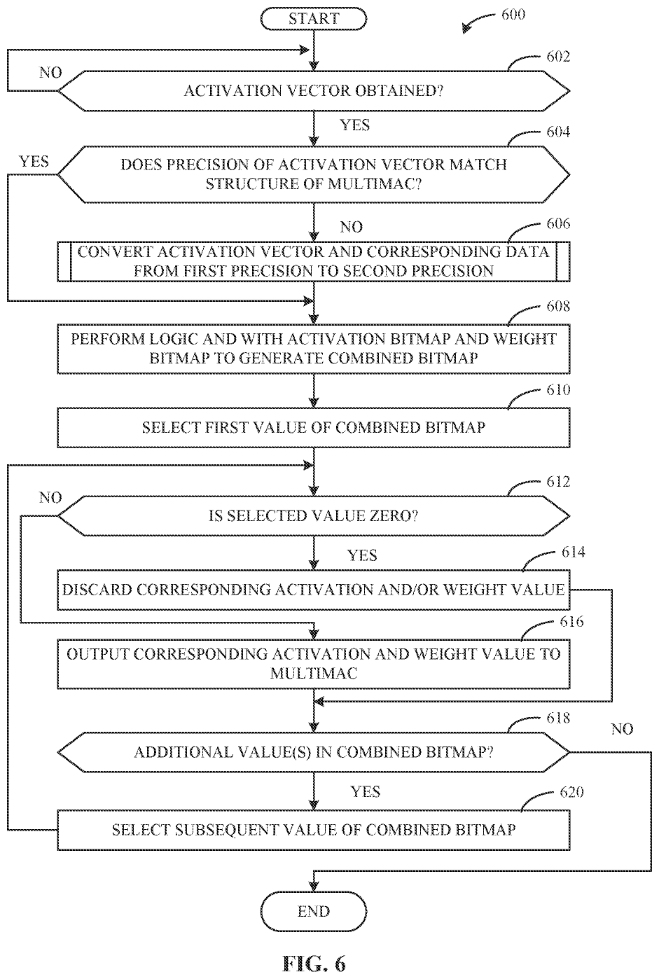

FIG. 6 is a flowchart representative of example machine readable instructions 600 which may be executed to implement any one of the components of the processing elements 110 of FIGS. 1-3C to select activation values and corresponding weight values to apply to the MultiMAC circuitry 216 of FIGS. 2-3C for multiplication and accumulation. Although the instructions 600 are described in conjunction with the example processing element 110 of FIGS. 1-3C, the instructions 600 may be described in conjunction with any neuron in any type of neural network or other AI-based model using any type of data (e.g., input data or activations).

At block 602, the example interface circuitry 200 determines if an activation vector (or matrix) has been obtained. The activation vector may be obtained as input data and/or as an output from a previous PE of a previous layer. The activation vector includes sparse values that correspond to the non-zero values of a dense vector. When an activation vector is obtained at the interface circuitry 200, a corresponding activation bitmap is obtained that corresponds to the location of zero values in the dense vector (or matrix) and non-zero values (e.g., that are included in the activation vector) in the dense vector. As explained above, the activation bitmap and sparse activation vector can be used to determine all the values of the corresponding dense vector.

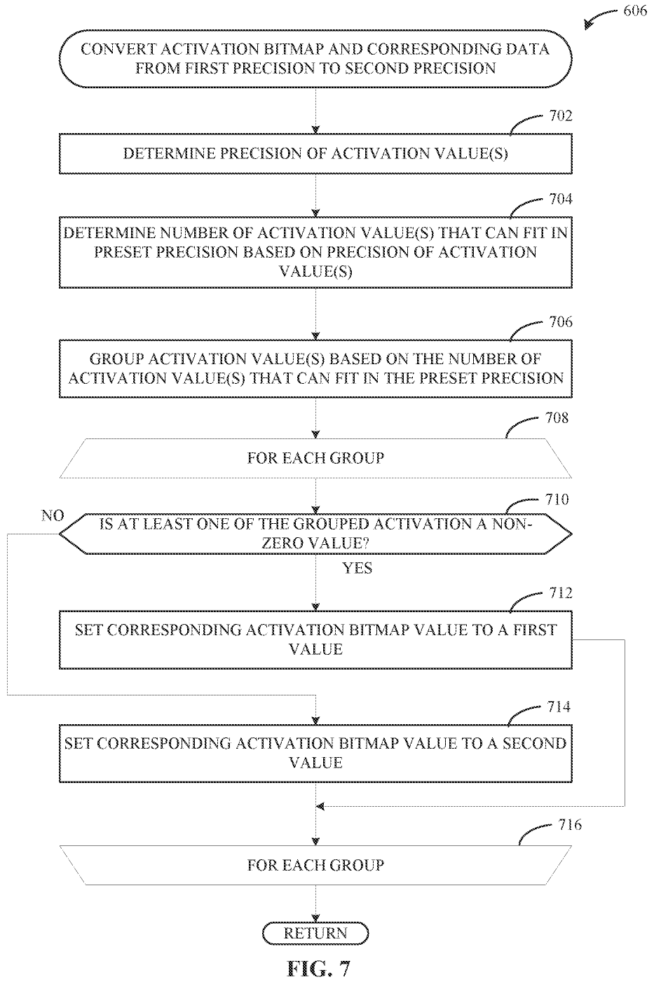

If the interface circuitry 200 has not obtained an activation vector (block 602: NO), control returns to block 602 until the activation vector is obtained. If the interface circuitry 200 has obtained an activation vector (block 602: YES), the example precision conversion circuitry 208 determines if the precision of the activation vector matches the structure of the MultiMAC circuitry 216. For example, the MultiMAC circuitry 216 may be structured to perform 8 byte operations, but the activations and/or weights may be a different precision (e.g., binary, 2 bytes, 4 bytes, and/or 8 bytes). If the example precision conversion circuitry 208 determines that the precision of the activation vector matches the structure of the MultiMAC circuitry 216 (block 604: YES), control continues to block 608. If the example precision conversion circuitry 208 determines that the precision of the activation vector does not match the structure of the MultiMAC circuitry 216 (block 604: NO), the example PE 110 converts the activation vector and corresponding data from the first precision (e.g., the precisions of the values of the activation vector) to the second precision (e.g., corresponding to the structure of the MultiMAC circuitry 216) (block 606), as further described below in conjunction with FIG. 7. Additionally or alternatively, the example weight vector may be converted from the precision of the weight vector values to the precision corresponding to the MultiMAC circuitry 216.

At block 608, the example logic gate 206 performs ‘AND’ logic with the activation bitmap and the weight bitmap and to generate a combined bitmap. The weight bitmap includes values corresponding to locations of zero and non-zero values of a dense weight vector that has been previously trained to perform a particular action. The combined bitmap identifies which activation values from the sparse activation vector and/or which weight values from the sparse weight vector can be discarded (e.g., because at the corresponding entry of the combined bitmap is zero, corresponding to a multiplication by 0).

At block 610, the example hardware control circuitry 212 selects the first value of the combined bitmap. At block 612, the example hardware control circuitry 212 determines whether the selected value is zero. If the example hardware control circuitry 212 determines that the selected value is zero (block 612: YES), the example hardware control circuitry 212 discards the corresponding activation and/or weight value from the activation vector and/or weight vector (block 614). For example, if the combined bitmap value is ‘0,’ the example hardware control circuitry 212 determines if either of the corresponding activation bitmap value or the weight bitmap value is non-zero. If either one of the corresponding activation bitmap value or the weight bitmap value is non-zero, the hardware control circuitry 212 discards the corresponding activation value or weight value from the activation vector or weight vector. If the example hardware control circuitry 212 determines that the selected value is not zero (block 612: NO), the example hardware control circuitry 212 accesses the corresponding activation value and weight value from the activation vector and the weight vector and outputs the values to the example MultiMAC circuitry 216 to perform a multiplication and accumulation function using the accessed activation value and weight value (block 616).

At block 618, the example hardware control circuitry 212 determines if there are additional values in the combined bitmap. If the example hardware control circuitry 212 determines that there is an additional value in the combined bitmap (block 618: YES), control returns to block 612 for another iteration. If the example hardware control circuitry 212 determines that there are no additional values in the combined bitmap (block 618: NO), control ends.

FIG. 7 is a flowchart representative of example machine readable instructions 606 which may be executed to implement any one of the components of the processing elements 110 of FIGS. 1-3C to convert an activation bitmap and corresponding data from a first precision to a second precision, as described above in conjunction with block 606 of FIG. 6. Although the instructions 606 are described in conjunction with converting an activation bitmap and activation data from an activation vector to a different precision, the instructions 606 may be used to convert a weight bitmap and weight data of a weight data to a different precision. Additionally, although the instructions 606 are described in conjunction with the example processing element 110 of FIGS. 1-3C, the instructions 606 may be described in conjunction with any neuron in any type of neural network or other AI-based model using any type of data (e.g., input data or activations).

At block 702, the example precision conversion circuitry 208 determines the precision of the activation value(s). The precision of the activation values may be preset and/or data identifying the precision may be sent to the PE 110 (e.g., with the activation vector). At block 704, the example precision conversion circuitry 208 determines the number of activation value(s) that can fit in a preset precision (e.g., corresponding to the structure of the MultiMAC circuitry 216) based on the precision of the activation value(s). For example, if the MultiMAC circuitry 216 is structured to perform 8 byte operations, and the precision of the activation(s) is 2 bytes, then the precision conversion circuitry 208 determines that four activation values can fit into the 8 byte operation (e.g., 8-byte/2-byte=4 values). At block 706, the example precision conversion circuitry 208 groups the activation value(s) based on the number of activation value(s) that can fit into the preset precision. Using the above-example, the 2-byte activation values are grouped into groups of four to generate groups that are 8-bytes of information.

Because the activation bitmap corresponds to the previous precision activation values, the bitmap needs to be adjusted and/or a new bitmap needs to be generated corresponding to the new precision activation values. For each group (e.g., each 8-byte group of 2-byte activation data) (blocks 708-716), the example bitmap generation circuitry 210 determines if at least one of the grouped activation values is a non-zero value (block 710). The example bitmap generation circuitry 210 may determine whether any one of the activation values in a group is non-zero by processing the activation values and/or by processing the corresponding activation bitmap values. If the example bitmap generation circuitry 210 determines that at least one of the grouped activation values is a non-zero value (block 710: YES), the example bitmap generation circuitry 210 sets the corresponding activation bitmap value to a first value (e.g., ‘1’), to indicate that at least one of the activation values in the group is non-zero. If the example bitmap generation circuitry 210 determines that at least one of the grouped activation values is not a non-zero value (block 710: NO), the example bitmap generation circuitry 210 sets the corresponding activation bitmap value to a second value (e.g., ‘0’), to indicate that at least one of the activation values in the group are zero. After all groups have been processed, control returns to block 608 of FIG. 6.

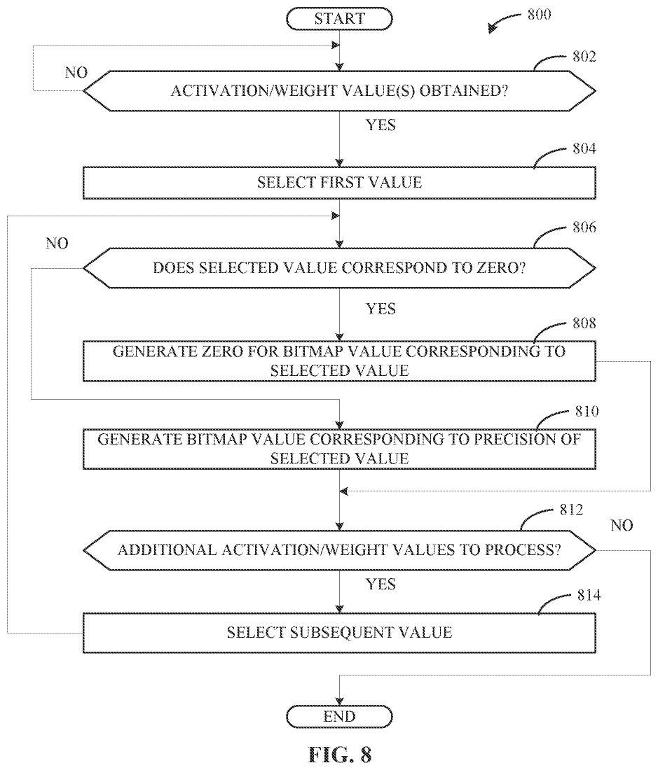

FIG. 8 is a flowchart representative of example machine readable instructions 800 which may be executed to implement any one of the components of the processing elements 110 of FIGS. 1-3C to generate a multi-bit bitmap for a dense vector (e.g., an input/activation vector/matrix and/or a weight vector/matrix). Although the instructions 800 are described in conjunction with the example processing element 110 of FIGS. 1-3C, the instructions 800 may be described in conjunction with any neuron in any type of neural network or other AI-based model using any type of data (e.g., input data or activations).

At block 802, the example interface circuitry 200 determines if the activation values and/or weight values (e.g., a vector/matrix of activation values and/or weight values) has been obtained. If the example interface circuitry 200 determines that the activation/weight value(s) has not been obtained (block 802: NO), control continues to block 802 until activation and/or weight values are obtained. If the example interface circuitry 200 determines that the activation/weight value(s) has not been obtained (block 802: YES), the example bitmap generation circuitry 210 selects a first value of the vector (or matrix) (block 804).

At block 806, the example bitmap generation circuitry 210 determines if the selected value corresponds to a zero. If the example bitmap generation circuitry 210 determines that the selected value corresponds to a zero (block 806: YES), the example bitmap generation circuitry 210 generates a zero for the bitmap value corresponding to the selected value (block 808). If the example bitmap generation circuitry 210 determines that the selected value does not correspond to zero (block 806: NO), the example bitmap generation circuitry 210 generates a bitmap value corresponding to the precision of the selected value (block 810). For example, the bitmap generation circuitry 210 may generate a ‘1’ for binary precision, a ‘2’ for a 2 byte value, a ‘3’ for a 4 byte value, etc.

At block 812, the example bitmap generation circuitry 210 determines if there is an addition activation or weight value to process. If the example bitmap generation circuitry 210 determines that there is an additional activation or weight value to process (block 812: YES), the example bitmap generation circuitry 210 selects a subsequent activation and/or weight value and control returns to block 806 to process the subsequent value. If the example bitmap generation circuitry 210 determines that there is not an additional activation or weight value to process (block 812: NO), control ends.

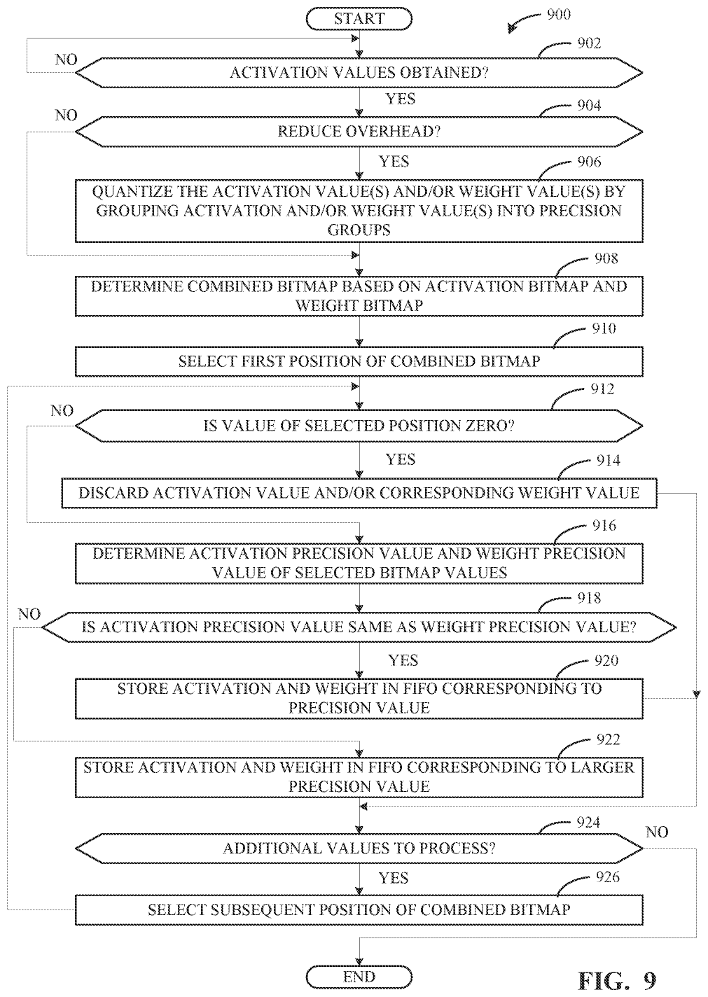

FIG. 9 is a flowchart representative of example machine readable instructions 900 which may be executed to implement any one of the components of the processing elements 110 of FIGS. 1-3C to process an sparse activation vector (or matrix) to store in a precision-based buffer (e.g., the buffers 332 and/or the example register(s) 202 of FIG. 3C). Although the instructions 900 are described in conjunction with the example processing element 110 of FIGS. 1-3C, the instructions 900 may be described in conjunction with any neuron in any type of neural network or other AI-based model using any type of data (e.g., input data or activations).

At block 900, the example interface circuitry 200 determines if activation values have been obtained. If the example interface circuitry 200 determines that activations have not been obtained (block 902: NO), control returns to block 902 until activations are obtained. If the example interface circuitry 200 determines that the activations have been obtained (block 902: YES), the example quantization circuitry 214 determines if overhead should be reduced (block 904). In some examples, the example quantization circuitry 214 may determine that overhead should be reduced based on user and/or manufacturer preferences. In some examples, the example quantization circuitry 214 determines the amount of overhead based on the activation data and determines that the amount of overhead should be reduced with the amount of overhead is above a threshold.

If the example quantization circuitry 214 determines not to reduce overhead (block 904: NO), control continues to block 908. If the example quantization circuitry 214 determines to reduce overhead (block 904: YES), the example quantization circuitry 214 quantizes the activation value(s) and/or weight value(s) by grouping activation and/or weight values into precision groups to reduce overhead (block 906), as further described above in conjunction with FIG. 2.

At block 908, the example logic gate 206 determines a combined bitmap by performing a logic ‘AND’ using the activation bitmap and the weight bitmap. As described above, the combined bitmap corresponds to products that will result in zero and can be skipped, and products that will result in a non-zero value. At block 910, the example hardware control circuitry 212 selects a first position of the combined bitmap. At block 912, the example hardware control circuitry 212 determines if the bitmap value of the selected position in the combined bitmap value is zero, thereby corresponding to a product that will result in a zero. If the example hardware control circuitry 212 determines that the bitmap value of the selected position in the combined bitmap value is zero (block 914: YES), the example hardware control circuitry 212 discards the activation value and/or corresponding weight value that corresponds to the combined bitmap value (block 914) and control continues to block 924. For example, if the combined bitmap for an element is 0 and the corresponding weight bitmap is ‘1’, then the weight value corresponding to the element is discarded to reduce the computational resources (e.g., the product will result in a 0 because the corresponding activation value is 0). If the example hardware control circuitry 212 determines that the bitmap value of the selected position in the combined bitmap value is not zero (block 914: NO), the example hardware control circuitry 212 determines the precision of the activation value (e.g., the activation precision) and the precision of the weight (e.g., the weight precision) using the respective multibit bitmaps (block 916). For example, if the activation multibit bitmap includes a ‘2’ in for the selected position, then the hardware control circuitry 212 can determine the precision corresponding to the value of ‘2.’

At block 918, the example hardware control circuitry 212 determines if the activation precision value and the weight precision value are the same. If the example hardware control circuitry 212 determines that the activation precision is the same as the weight precision (block 918: YES), the example hardware control circuitry 212 stores the activation and weight in the FIFO buffer (e.g., one of the registers(s) 202 of FIG. 2 and/or FIFO buffers 332, 334, 336 of FIG. 3C) that corresponds to the precision value (block 920) and control continues to block 924. For example, if the precision of the weight value and the activation value is 2 byte (e.g., INT2), the example hardware control circuitry 212 stores the corresponding weight value and the activation value in a FIFO buffer that stores 2 byte values (e.g., the example buffer 332 of FIG. 3C). If the example hardware control circuitry 212 determines that the activation precision is not the same as the weight precision (block 918: NO), the example hardware control circuitry 212 stores the activation value and corresponding weight value in a FIFO buffer corresponding to the larger precision value (block 922). For example, if the activation value is a 2 byte value and the weight value is a 4 byte value, the example hardware control circuitry 212 may store the 2 byte activation value and the 4 byte weight value in the FIFO corresponding to 4 bytes (e.g., the example FIFO buffer 334 because 4>2). In such an example, the hardware control circuitry 212 may include 2 bytes of null or zero data with the activation value to fill the 4 byte FIFO buffer entry.

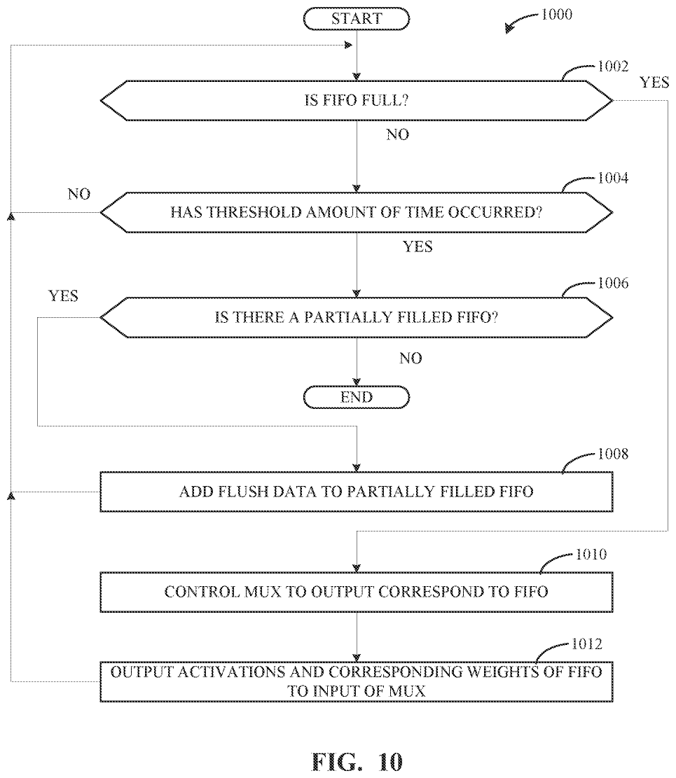

At block 924, the example hardware control circuitry 212 determines if there are additional value to process. If the example hardware control circuitry 212 determines that there are additional values to process (block 924: YES), the example hardware control circuitry 212 selects a subsequent position of the combined bitmap (block 926) and control returns to block 912 to process subsequent activation and weight values. If the example hardware control circuitry 212 determines that there are additional values to process (block 924: NO), control ends. The process of outputting the data from the FIFO buffers (e.g., the example buffers 332, 334, 336 of FIG. 3C) is further described below in conjunction with FIG. 10.

FIG. 10 is a flowchart representative of example machine readable instructions 1000 which may be executed to implement any one of the components of the processing elements 110 of FIGS. 1-3C to output the activation and corresponding weight data stored in the precision-based buffer (e.g., the buffers 332, 334, 336 of FIG. 3C) to be processed by the MultiMAC circuitry 216. Although the instructions 1000 are described in conjunction with the example processing element 110 of FIGS. 1-3C, the instructions 1000 may be described in conjunction with any neuron in any type of neural network or other AI-based model using any type of data (e.g., input data or activations).

At block 1002, the example hardware control circuitry 212 determines if any one of the FIFO buffers (e.g., the example FIFO buffers 332, 334, 336 of FIG. 3C) during the storing process of FIG. 9. If the example hardware control circuitry 212 determines that one of the FIFO buffers is full (block 1002: YES), control continues to block 1010, as further described below. If the example hardware control circuitry 212 determines that none of the FIFO buffers are full (block 1002: NO), the example hardware control circuitry 212 determines if a threshold amount of time has occurred (block 1004). For example, there may be a case where a FIFO is not full but there are no more activations to fill the FIFO. In this example, a timer can be used to determine when no additional elements are left and the FIFOs may need to be flushed.

If the example hardware control circuitry 212 determines that a threshold amount of time has not occurred (block 1004: NO), then control returns to block 1002 until a FIFO is full or the threshold amount of time has occurred. If the example hardware control circuitry 212 determines that a threshold amount of time has not occurred (block 1004: YES), the hardware control circuitry 212 determines if there is a partially filled FIFO buffer (block 1006). If the example hardware control circuitry 212 determines that there is a partially filled FIFO (block 1006: YES), the example hardware control circuitry 212 adds flush data to the partially filled FIFO buffer (block 1008) to cause the FIFO buffer to be full and control returns to block 1002 to flush the remaining data stored in the partially filled FIFO buffer. If the example hardware control circuitry 212 determines that there is no partially filled FIFO buffer (block 1006: NO), control ends.

At block 1010, the example hardware control circuitry 212 controls a MUX (e.g., the MUX 38 of FIG. 3C) to output the data corresponding to the full FIFO to the MultiMAC circuitry 216. For example, the hardware control circuitry 212 sends one or more control signals to MUX to ensure that the output of the corresponding FIFO is input to the MultiMAC circuitry 216. At block 1012, the hardware control circuitry 212 controls the corresponding FIFO to output the values stored in the FIFO. Accordingly, the values are output to the MultiMAC circuitry 216 for multiplication and accumulation via the MUX.

FIG. 11 is a block diagram of an example processor platform 1100 structured to execute the instructions of FIGS. 5-10 to implement the example PE 110 of FIGS. 1-4. The processor platform 1100 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 1112 implements at least one of the example interface circuitry 200, the example data rearrangement circuitry 204, the example logic gate 206, the example precision conversion circuitry 208, the example bitmap generation circuitry 210, the example hardware control circuitry 212, the example quantization circuitry 214, the example MultiMAC circuitry 216, the example find first sparsity acceleration logic 308, the example concatenating circuitry 314, the example DPA logic 330, and the example MUX 338 of FIGS. 1-4.

The processor 1112 of the illustrated example includes a local memory 1113 (e.g., a cache). In the example of FIG. 11, the local memory 1113 implements the example register(s) 202 and/or the example buffers 332, 334, 336 or FIGS. 2 and/or 3C. The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller. The example local memory 1113, the example volatile memory 1114, and/or the example non-volatile memory 1116 can implement the memory 106 of FIG. 1. Any one of the example volatile memory 1114, the example non-volatile memory 1116, and/or the example mass storage 1128 may implement the example system memory 106, the example register(s) 202, and/or the example buffers 332, 334, 336 or FIGS. 1, 2 and/or 3C.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 1132 of FIGS. 5-10 may be stored in the mass storage device 1128, in the volatile memory 1114, in the non-volatile memory 1116, and/or on a removable non-transitory computer readable storage medium such as a CD or DVD.

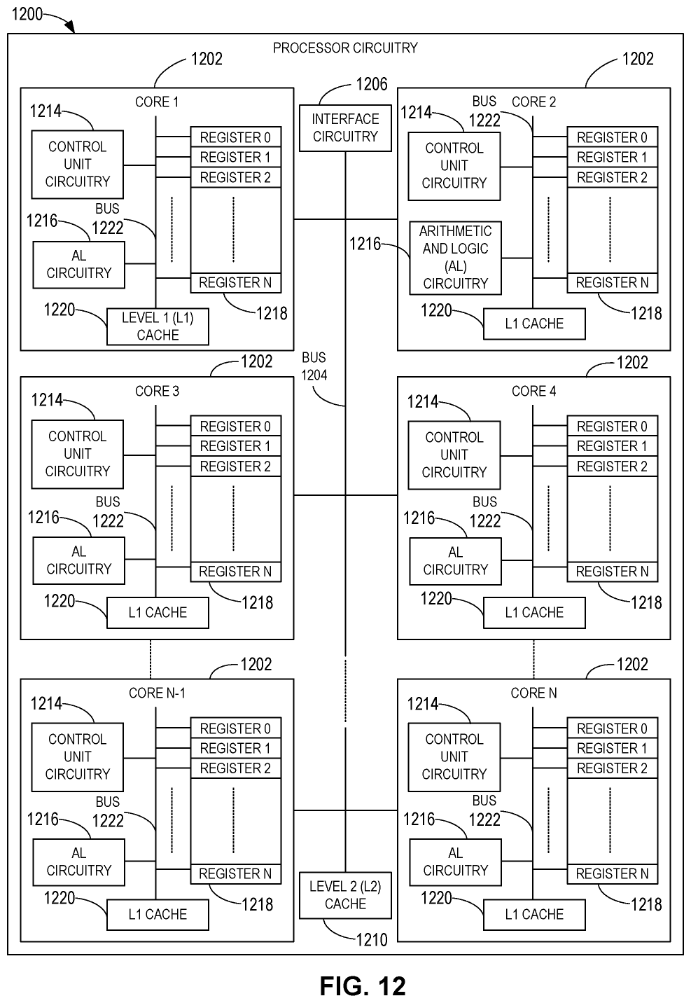

FIG. 12 is a block diagram of an example implementation of the processor circuitry 1112 of FIG. 11. In this example, the processor circuitry 1112 of FIG. 11 is implemented by a microprocessor 1200. For example, the microprocessor 1300 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 5-10.

The cores 1202 may communicate by an example bus 1204. In some examples, the bus 1204 may implement a communication bus to effectuate communication associated with one(s) of the cores 1202. For example, the bus 1204 may implement at least one of an Inter-Integrated Circuit (I2C) bus, a Serial Peripheral Interface (SPI) bus, a PCI bus, or a PCIe bus. Additionally or alternatively, the bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L1 cache 1220, and an example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The bus 1220 may implement at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

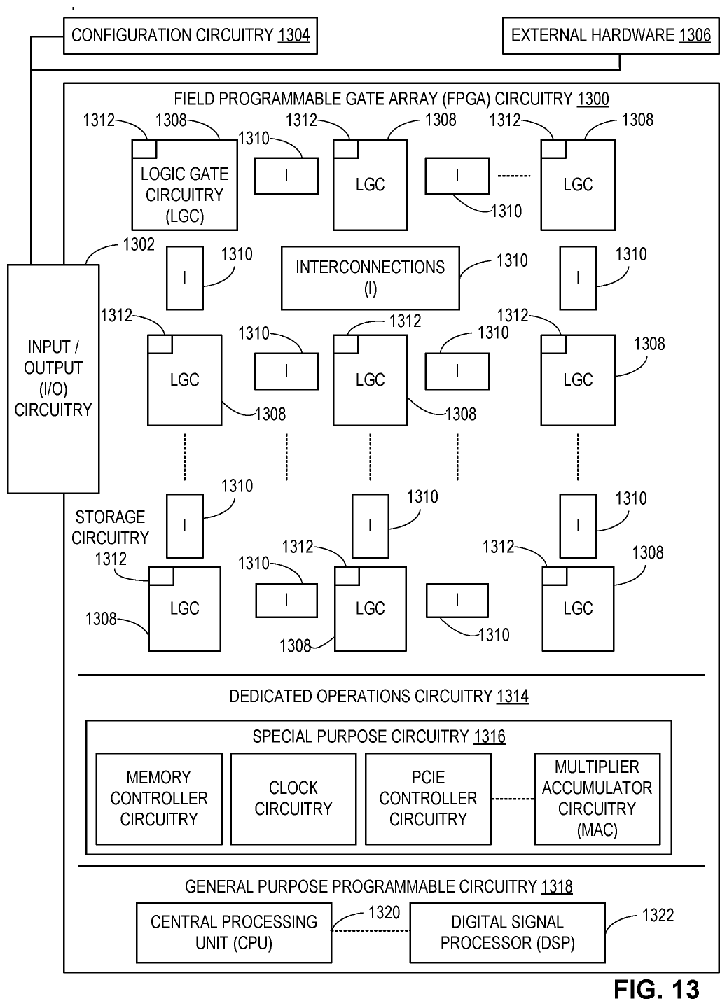

FIG. 13 is a block diagram of another example implementation of the processor circuitry 1112 of FIG. 11. In this example, the processor circuitry 1112 is implemented by FPGA circuitry 1300. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 5-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 5-10. In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 5-10. As such, the FPGA circuitry 1300 may be structured to effectively instantiate some or all of the machine readable instructions of the flowcharts of FIGS. 5-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIG. FIGS. 5-10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware (e.g., external hardware circuitry) 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and interconnections 1310 are configurable to instantiate one or more operations that may correspond to at least some of the machine readable instructions of FIGS. 5-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 5-10 may be executed by one or more of the cores 1202 of FIG. 12 and a second portion of the machine readable instructions represented by the flowcharts of FIGS. 5-10 may be executed by the FPGA circuitry 1300 of FIG. 13.

In some examples, the processor circuitry 1112 of FIG. 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

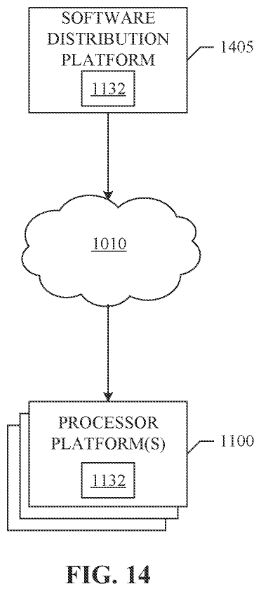

A block diagram illustrating an example software distribution platform 1405 to distribute software such as the example computer readable instructions 1132 of FIG. 11 to third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the computer readable instructions 1132, which may correspond to the example computer readable instructions 500, 600, 606, 800, 900, 1000, 1132 of FIGS. 5-11, as described above. The one or more servers of the example software distribution platform 1405 are in communication with a network 1410, which may correspond to any one or more of the Internet and/or any of the example networks 1126 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1132 from the software distribution platform 1405. For example, the software, which may correspond to the example computer readable instructions 1132 of FIG. 11, may be downloaded to the example processor platform 1400, which is to execute the computer readable instructions 1132 to implement the PE 110. In some example, one or more servers of the software distribution platform 1405 periodically offer, transmit, and/or force updates to the software (e.g., the example computer readable instructions 1132 of FIG. 11) to ensure improvements, patches, updates, etc. are distributed and applied to the software at the end user devices.

Example methods, apparatus, systems, and articles of manufacture to perform low overhead sparsity acceleration logic for multi-precision dataflow in deep neural network accelerators are disclosed herein. Further examples and combinations thereof include the following:

Example 1 includes a processing element of a neural network to perform sparsity acceleration logic for multi-precision dataflow, the processing element comprising a first buffer to store data corresponding to a first precision, the first buffer sized to store a first number of activation values corresponding to a structure of multiply and accumulate circuitry, a second buffer to store data corresponding to a second precision higher than the first precision, the second buffer sized to store a second number of activation values corresponding to the structure of the multiply and accumulate circuitry, and hardware control circuitry to process a first multibit bitmap to determine an activation precision of an activation value, the first multibit bitmap including values corresponding to different precisions, process a second multibit bitmap to determine a weight precision of a weight value, the second multibit bitmap including values corresponding to different precisions, and store the activation value and the weight value in the second buffer when at least one of the activation precision or the weight precision corresponds to the second precision.

Example 2 includes the processing element of example 1, further including bitmap generation circuitry to generate the first multibit bitmap based on the activation precision.

Example 3 includes the processing element of example 1, wherein the first multibit bitmap identifies precisions of non-zero values of dense activation values.

Example 4 includes the processing element of example 1, wherein the hardware control circuitry is to, if the activation value and the weight value are stored in the second buffer, add a value to at least one the activation value or the weight value to fill space in the second buffer.

Example 5 includes the processing element of example 1, further including a multiplexer including inputs coupled to the first buffer and the second buffer and an output coupled to the multiply and accumulate circuitry.

Example 6 includes the processing element of example 5, wherein the hardware control circuitry is to control the multiplexer to (a) output values stored in the first buffer when the first buffer is full and (b) output values stored in the second buffer when the second buffer is full.

Example 7 includes the processing element of example 1, further including quantization circuitry to quantize (a) the activation value into the activation precision and (b) the weight value into the weight precision to reduce overhead.

Example 8 includes the processing element of example 1, further including a logic gate to generate a combined multibit bitmap based on a logic AND function of the first multibit bitmap corresponding to the activation value and the second multibit bitmap corresponding to the weight value.

Example 9 includes the processing element of example 8, wherein the hardware control circuitry is to discard at least one of the activation value or the weight value when at least a value of the combined bitmap corresponding to the activation value and the precision corresponds to zero.

Example 10 includes an apparatus to perform sparsity acceleration logic for multi-precision dataflow, the apparatus comprising a first buffer to store data corresponding to a first precision, the first buffer sized to store a first number of activation values corresponding to a structure of multiply and accumulate circuitry, a second buffer to store data corresponding to a second precision higher than the first precision, the second buffer sized to store a second number of activation values corresponding to the structure of the multiply and accumulate circuitry, and instructions, processor circuitry to execute the instructions to process a first multibit bitmap to determine an activation precision of an activation value, the first multibit bitmap including values corresponding to different precisions, process a second multibit bitmap to determine a weight precision of a weight value, the second multibit bitmap including values corresponding to different precisions, and store the activation value and the weight value in the first buffer when the activation precision and the weight precision corresponds to the first precision.

Example 11 includes the apparatus of example 10, wherein the processor circuitry is to generate the first multibit bitmap based on the activation precision.

Example 12 includes the apparatus of example 10, wherein the first multibit bitmap identifies precisions of non-zero values of dense activation values.

Example 13 includes the apparatus of example 10, wherein the processor circuitry is to, if the activation value and the weight value are stored in the second buffer, add a value to at least one the activation value or the weight value to fill space in the second buffer.

Example 14 includes the apparatus of example 10, further including a multiplexer including inputs coupled to the first buffer and the second buffer and an output coupled to the multiply and accumulate circuitry.

Example 15 includes the apparatus of example 14, wherein the processor circuitry is to control the multiplexer to (a) output values stored in the first buffer when the first buffer is full and (b) output values stored in the second buffer when the second buffer is full.

Example 16 includes the apparatus of example 10, wherein the processor circuitry is to quantize (a) the activation value into the activation precision and (b) the weight value into the weight precision to reduce overhead.

Example 17 includes the apparatus of example 10, wherein the processor circuitry is to generate a combined multibit bitmap based on a logic AND function of the first multibit bitmap corresponding to the activation value and the second multibit bitmap corresponding to the weight value.

Example 18 includes the apparatus of example 17, wherein the processor circuitry is to discard at least one of the activation value or the weight value when at least a value of the combined bitmap corresponding to the activation value and the precision corresponds to zero.

Example 19 includes a non-transitory computer readable medium comprising instructions, which when executed, cause one or more processors to at least store data corresponding to a first precision in a first buffer, the first buffer sized to store a first number of activation values corresponding to a structure of multiply and accumulate circuitry, store data corresponding to a second precision higher than the first precision in a second buffer, the second buffer sized to store a second number of activation values corresponding to the structure of the multiply and accumulate circuitry, process a first multibit bitmap to determine an activation precision of an activation value, the first multibit bitmap including values corresponding to different precisions, process a second multibit bitmap to determine a weight precision of a weight value, the second multibit bitmap including values corresponding to different precisions, and store the activation value and the weight value in the first buffer or the second buffer based on the activation precision or the weight precision.

Example 20 includes the computer readable medium of example 19, wherein the instructions cause the one or more processors to generate the first multibit bitmap based on the activation precision.

Example 21 includes the computer readable medium of example 19, wherein the first multibit bitmap identifies precisions of non-zero values of dense activation values.

Example 22 includes the computer readable medium of example 19, wherein the instructions cause the one or more processors to, if the activation value and the weight value are stored in the second buffer, add a value to at least one the activation value or the weight value to fill space in the second buffer.

Example 23 includes the computer readable medium of example 19, wherein the instructions cause the one or more processors to control a multiplexer to (a) output values stored in the first buffer when the first buffer is full and (b) output values stored in the second buffer when the second buffer is full.

Example 24 includes the computer readable medium of example 19, wherein the instructions cause the one or more processors to quantize (a) the activation value into the activation precision and (b) the weight value into the weight precision to reduce overhead.

Example 25 includes the computer readable medium of example 19, wherein the instructions cause the one or more processors to generate a combined multibit bitmap based on a logic AND function of the first multibit bitmap corresponding to the activation value and the second multibit bitmap corresponding to the weight value.

Example 26 includes the computer readable medium of example 25, wherein the instructions cause the one or more processors to discard at least one of the activation value or the weight value when at least a value of the combined bitmap corresponding to the activation value and the precision corresponds to zero.

Examples disclosed herein perform low overhead sparsity acceleration logic for multi-precision dataflow in deep neural network accelerators. Examples disclosed herein utilize processing elements that are able to process and/or perform a multiplication and accumulation function at different precisions even though the MAC hardware is structured to perform a particular byte operation. Such techniques result in an 8-300% improvement in raw operations per second (OPS) and/or trillion or terral operations per second (TOPS). Additionally, examples disclosed herein reduces execution cycles and increase speed during the execution. The performance improvements corresponding to examples disclosed herein is 1.08X-1.71X for 4-bit quantization convolution, 1.11X-3X for 2-bit quantized values, and 1.16X-4.5X for binary convolution. Additionally, quantizing values results the efficiency by 33% and reduces the weight memory footprint by 12.5%, with a compute-bounded improvement of 1.33 and a memory bounded improvement of 1.14. Additionally, examples disclosed herein result in a geomean performance improvement of 22% across several network topologies. Accordingly, the disclosed methods, apparatus and articles of manufacture are accordingly directed to one or more improvement(s) in the functioning of a neural network.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A processing element of a neural network to perform sparsity acceleration logic for multi-precision dataflow, the processing element comprising:
a first buffer to store data corresponding to a first precision, the first buffer sized to store a first number of activation values corresponding to a structure of multiply and accumulate circuitry;
a second buffer to store data corresponding to a second precision higher than the first precision, the second buffer sized to store a second number of activation values corresponding to the structure of the multiply and accumulate circuitry; and
hardware control circuitry to:
process a first multibit bitmap to determine an activation precision of an activation value, the first multibit bitmap including values corresponding to different precisions;
process a second multibit bitmap to determine a weight precision of a weight value, the second multibit bitmap including values corresponding to different precisions; and
store the activation value and the weight value in the second buffer when at least one of the activation precision or the weight precision corresponds to the second precision.

2. The processing element of claim 1, further including bitmap generation circuitry to generate the first multibit bitmap based on the activation precision.

3. The processing element of claim 1, wherein the first multibit bitmap identifies precisions of non-zero values of dense activation values.

4. The processing element of claim 1, wherein the hardware control circuitry is to, if the activation value and the weight value are stored in the second buffer, add a value to at least one the activation value or the weight value to fill space in the second buffer.

5. The processing element of claim 1, further including a multiplexer including inputs coupled to the first buffer and the second buffer and an output coupled to the multiply and accumulate circuitry.

6. The processing element of claim 5, wherein the hardware control circuitry is to control the multiplexer to (a) output values stored in the first buffer when the first buffer is full and (b) output values stored in the second buffer when the second buffer is full.

7. The processing element of claim 1, further including quantization circuitry to quantize (a) the activation value into the activation precision and (b) the weight value into the weight precision to reduce overhead.

8. The processing element of claim 1, further including a logic gate to generate a combined multibit bitmap based on a logic AND function of the first multibit bitmap corresponding to the activation value and the second multibit bitmap corresponding to the weight value.

9. The processing element of claim 8, wherein the hardware control circuitry is to discard at least one of the activation value or the weight value when at least a value of the combined bitmap corresponding to the activation value and the precision corresponds to zero.

10. An apparatus to perform sparsity acceleration logic for multi-precision dataflow, the apparatus comprising:
a first buffer to store data corresponding to a first precision, the first buffer sized to store a first number of activation values corresponding to a structure of multiply and accumulate circuitry;
a second buffer to store data corresponding to a second precision higher than the first precision, the second buffer sized to store a second number of activation values corresponding to the structure of the multiply and accumulate circuitry; and
instructions;
processor circuitry to execute the instructions to:
process a first multibit bitmap to determine an activation precision of an activation value, the first multibit bitmap including values corresponding to different precisions;
process a second multibit bitmap to determine a weight precision of a weight value, the second multibit bitmap including values corresponding to different precisions; and
store the activation value and the weight value in the first buffer when the activation precision and the weight precision corresponds to the first precision.

11. The apparatus of claim 10, wherein the processor circuitry is to generate the first multibit bitmap based on the activation precision.

12. The apparatus of claim 10, wherein the first multibit bitmap identifies precisions of non-zero values of dense activation values.

13. The apparatus of claim 10, wherein the processor circuitry is to, if the activation value and the weight value are stored in the second buffer, add a value to at least one the activation value or the weight value to fill space in the second buffer.

14. The apparatus of claim 10, further including a multiplexer including inputs coupled to the first buffer and the second buffer and an output coupled to the multiply and accumulate circuitry.

15. The apparatus of claim 14, wherein the processor circuitry is to control the multiplexer to (a) output values stored in the first buffer when the first buffer is full and (b) output values stored in the second buffer when the second buffer is full.

16. The apparatus of claim 10, wherein the processor circuitry is to quantize (a) the activation value into the activation precision and (b) the weight value into the weight precision to reduce overhead.

17. The apparatus of claim 10, wherein the processor circuitry is to generate a combined multibit bitmap based on a logic AND function of the first multibit bitmap corresponding to the activation value and the second multibit bitmap corresponding to the weight value.

18. The apparatus of claim 17, wherein the processor circuitry is to discard at least one of the activation value or the weight value when at least a value of the combined bitmap corresponding to the activation value and the precision corresponds to zero.

19. A non-transitory computer readable medium comprising instructions, which when executed, cause one or more processors to at least:
store data corresponding to a first precision in a first buffer, the first buffer sized to store a first number of activation values corresponding to a structure of multiply and accumulate circuitry;
store data corresponding to a second precision higher than the first precision in a second buffer, the second buffer sized to store a second number of activation values corresponding to the structure of the multiply and accumulate circuitry;
process a first multibit bitmap to determine an activation precision of an activation value, the first multibit bitmap including values corresponding to different precisions;
process a second multibit bitmap to determine a weight precision of a weight value, the second multibit bitmap including values corresponding to different precisions; and
store the activation value and the weight value in the first buffer or the second buffer based on the activation precision or the weight precision.

20. The computer readable medium of claim 19, wherein the instructions cause the one or more processors to generate the first multibit bitmap based on the activation precision.

21. The computer readable medium of claim 19, wherein the first multibit bitmap identifies precisions of non-zero values of dense activation values.

22. The computer readable medium of claim 19, wherein the instructions cause the one or more processors to, if the activation value and the weight value are stored in the second buffer, add a value to at least one the activation value or the weight value to fill space in the second buffer.

23. The computer readable medium of claim 19, wherein the instructions cause the one or more processors to control a multiplexer to (a) output values stored in the first buffer when the first buffer is full and (b) output values stored in the second buffer when the second buffer is full.

24. The computer readable medium of claim 19, wherein the instructions cause the one or more processors to quantize (a) the activation value into the activation precision and (b) the weight value into the weight precision to reduce overhead.

25. The computer readable medium of claim 19, wherein the instructions cause the one or more processors to generate a combined multibit bitmap based on a logic AND function of the first multibit bitmap corresponding to the activation value and the second multibit bitmap corresponding to the weight value.
